(19) United States
(12) Patent Application Publication
(10) Pub. No.: US 2017/0006525 A1
(43) Pub. Date: Jan. 5, 2017

(54) TERMINAL APPARATUS, BASE STATION APPARATUS, COMMUNICATION SYSTEM, COMMUNICATION METHOD, AND INTEGRATED CIRCUIT

(71) Applicant: Sharp Kabushiki Kaisha, Sakai-shi, Osaka (JP)

(72) Inventors: Alvaro RUIZ DELGADO, Sakai-shi (JP); Kazuyuki SHIMEZAWA, Sakai-shi (JP); Toshizo NOGAMI, Sakai-shi (JP); Kimihiko IMAMURA, Sakai-shi (JP); Naoki KUSASHIMA, Sakai-shi (JP); Wataru OUCHI, Sakai-shi (JP)

(21) Appl. No.: 15/122,266

(22) PCT Filed: Mar. 10, 2015
(86) PCT No.: PCT/JP2015/001289

§ 371 Date: Aug. 29, 2016

Related U.S. Application Data
(60) Provisional application No. 61/968,013, filed on Mar. 20, 2014.

(51) Int. Cl. H04W 48/12; H04W 72/04; H04W 4/06; H04W 52/02

(52) U.S. Cl. CPC H04W 48/12; H04W 52/0206; H04W 72/0446; H04W 72/042; H04W 4/06

(57) ABSTRACT

A serving cell in a dormant state transmits discovery signals to let mobile station devices be aware of its presence. The mobile station devices are configured with a series of discovery signal candidates, which they monitor in the discovery signal burst subframes. A mobile station device detecting a particular discovery signal candidate can make some assumptions relative to the dormant cell.

### TECHNICAL FIELD

The present document describes methods and processes applicable to wireless communication systems, with a focus on a discovery signal used by some dormant cells in LTE to make mobile station devices aware of their existence.

### BACKGROUND ART

The Third Generation Partnership Project (3GPP) is constantly studying the evolution of the radio access schemes and radio networks for cellular mobile communications (hereinafter referred to as “Long Term Evolution (LTE)” or “Evolved Universal Terrestrial Radio Access (EUTRA)”. In LTE, the Orthogonal Frequency Division Multiplexing (OFDM) scheme, which is a multi-carrier transmission scheme, is used as a communication scheme for wireless communication from a base station device (hereinafter also referred to as “base station apparatus”, “base station”, “eNB”, “access point”) to a mobile station device (herein after also referred to as “mobile station”, “terminal station”, “terminal station apparatus”, “user equipment”, “UE”, “user”). The base station device has one or more serving cells configured (hereinafter also referred to as “cell”), and the communication with the mobile station device is performed through them. Also, the Single-Carrier Frequency Division Multiple Access (SC-FDMA) scheme, which is a single-carrier transmission scheme, is used as a communications scheme for wireless communication from a mobile station device to a base station device (uplink)

In 3GPP, studies are being performed to allow radio access schemes and radio networks which realize higher-speed data communication using a broader frequency band than that of LTE (hereinafter referred to as “Long Term Evolution-Advanced (LTE-A)” or “Advanced Evolved Universal Terrestrial Radio Access (A-EUTRA)”) to have backward compatibility with LTE. That is, a base station device of LTE-A is capable of simultaneously performing wireless communication with mobile station devices of both LTE-A and LTE, and a mobile station device of LTE-A is capable of performing wireless communication with base station devices of both LTE-A and LTE. The channel structure of LTE-A is the same as that of LTE, and it is described in Non Patent Literature (NPL) 1 and 2.

In LTE, the base station device transmits the control information through the Physical Downlink Control Channel (PDCCH) or the enhanced PDCCH (ePDCCH or EPDCCH). The mobile stations monitor the PDCCH region looking for messages directed to them, more specifically a subspace of that region called “search space”. The search space to monitor for messages specifically addressed to the individual mobile station devices is called User Search Space (USS). The search space to monitor to look for messages addressed to a particular mobile station device or a group thereof is called Common Search Space (CSS). In the ePDCCH case, the mobile station devices monitor a subspace of the ePDCCH region looking for messages specifically addressed to the individual mobile station devices (ePDCCH USS). The base station device can configure the mobile station devices through the use of Radio Resource Control (RRC) messages, as described in NPL 3.

LTE allows two or more serving cells to be aggregated to increase the peak data rate a mobile station device is capable of achieving. Typically a mobile station device sends its uplink control information through the PUSCH (Physical Uplink Control Channel) of only one cell, which is known as the primary cell, although LTE is investigating ways to allow mobile station device to transmit this information to secondary cells as well.

In some cases some cells can be deactivated, entering into a dormant state, under certain load conditions of the network. These cells can be reactivated to supplement the capacity when needed. Dormant cells periodically broadcast a discovery signal to allow mobile station devices to detect their presence.

### CITATION LIST

### Non Patent Literature

NPL 1: 3rd Generation Partnership Project; Technical Specification Group Radio Access Network; Evolved Universal Terrestrial Radio Access (E-UTRA); Physical Channels and Modulation (Release 11), 3GPP TS36. 211 v11. 5. 0. (2013-12)<URL:http://www.3gpp.org/ftp/Specs/html-info/36211.htm>

NPL 2: 3rd Generation Partnership Project; Technical Specification Group Radio Access Network; Evolved Universal Terrestrial Radio Access (E-UTRA); Physical layer procedures (Release 11), 3GPP TS36. 213 v11. 5. 0. (2013-12)<URL:http://www.3gpp.org/ftp/Specs/html-info/36213.htm>

NPL 3: 3rd Generation Partnership Project; Technical Specification Group Radio Access Network; Evolved Universal Terrestrial Radio Access (E-UTRA); Radio Resource Control (RRC); Protocol specification (Release 11), 3GPP TS36. 331 v11. 6. 0. (2013-12)<URL:http://www.3gpp.org/ftp/Specs/html-info/36331.htm>

### SUMMARY OF INVENTION

### Technical Problem

In the related art a serving cell is capable of entering a low energy consumption mode (off state, or dormancy). A cell in the dormant state does not transmit normal signals, achieving energy saving and avoiding interfering neighboring cells. However, it is unclear how the mobile station devices can detect the presence of a dormant cell in their surroundings and decide if they want to report the cell to another active cell (triggering the decision of whether to wake the dormant cell up or not) or if they wait for the dormant cell to wake up if the cell is already in the process of doing that.

The present invention has been made in view of the above-described points, and an object thereof is to provide a mobile station device, a base station device, a wireless communication system, a wireless communication method, and an integrated circuit enabling a scenario in which the mobile station device can detect a dormant cell and roughly discern between different states the dormant cell may be in.

### Solution to Problem

(1) The present invention has been made to solve the above-described problem, and according to one embodiment of the present invention, there is provided a mobile station device comprising a first circuit configured with a plurality of discovery signal candidates; and a second circuit adapted to perform monitoring for the discovery signal candidates; and a third circuit adapted to identify a detected discovery signal with one of the discovery signal candidates.

(2) A mobile station device according to another aspect of the present invention is constituted such that, in the mobile station device above, the discovery signal candidates differ between them in the combination of reference signals they are configured with, a first discovery signal candidate being based on a combination of reference signals; and a second discovery signal candidate being based on a different combination of reference signals; and subsequently configured discovery signal candidates being based on a combination of reference signals that is different from the combination of reference signals of the previously configured discovery signal candidates.

(3) A mobile station device according to another aspect of the present invention is constituted such that, in the mobile station device above, the discovery signal candidates differ between them in the subset of subframes within the discovery signal burst they are transmitted on, a first discovery signal candidate being transmitted on a subset of subframes; and a second discovery signal candidate being transmitted on a different subset of subframes; and subsequently configured discovery signal candidates being transmitted on a subset of subframes that is different from the subset of subframes of the previously configured discovery signal candidates.

(4) A mobile station device according to another aspect of the present invention is constituted such that, in the mobile station device above, the discovery signal candidates differ between them in the subset of resource elements within the physical resource block they are transmitted on, a first discovery signal candidate being transmitted on a subset of resource elements; and a second discovery signal candidate being transmitted on a different subset of resource elements; and subsequently configured discovery signal candidates being transmitted on a subset of resource elements that is different from the subset of resource elements of the previously configured discovery signal candidates.

(5) A mobile station device according to another aspect of the present invention is constituted such that, in the mobile station device above, the discovery signal candidates differ between them in the transmission power used for their transmission, a first discovery signal candidate being transmitted with a given transmission power; and a second discovery signal candidate being transmitted with a different transmission power; and subsequently configured discovery signal candidates being transmitted with a transmission power that is different from the transmission power of the previously configured discovery signal candidates.

(6) A mobile station device according to another aspect of the present invention is constituted such that, in the mobile station device above, the discovery signal candidates differ between them in the period they are transmitted with, the period being a multiple of the period of the discovery signal burst, a first discovery signal candidate being transmitted with a given period; and a second discovery signal candidate being transmitted with a different period; and subsequently configured discovery signal candidates being transmitted with a period that is different from the period of the previously configured discovery signal candidates.

(7) A mobile station device according to another aspect of the present invention is constituted such that, in the mobile station device above, the mobile station device assumes a state or set of parameters of the serving cell transmitting a detected discovery signal based on the discovery signal candidate the detected discovery signal matches with.

(8) A mobile station device according to another aspect of the present invention is constituted such that the mobile station device above further comprises a circuit to compare the RRM measurement of the detected discovery signals' cells; and another circuit to report to the primary serving cell the identities of the cells with the largest RRM measured values.

(9) A mobile station device according to another aspect of the present invention is constituted such that the mobile station device above further comprises a circuit to compare the RRM measurement of the detected discovery signals' cells; and another circuit to monitor the PDCCH/EPDCCH of a cell whose detected discovery signal's RRM measurement is over a configured threshold and matches one of the configured discovery signal candidates.

(10) A mobile station device according to another aspect of the present invention is constituted such that, in the mobile station device above, the RRM measurements is performed with an offset whose value depends on the configured discovery signal candidate the discovery signal matches with before performing RRM measurement comparisons.

(11) A mobile station device according to another aspect of the present invention is constituted such that, in the mobile station device above, the mobile station device starts a procedure for cell detection in a cell whose discovery signal matches one of the configured discovery signal candidates.

(12) A mobile station device according to another aspect of the present invention is constituted such that the mobile station device above further comprises a circuit to prepare a first RRM report format for RRM measurements of discovery signals matching a first subset of discovery signal candidates; and another circuit to prepare a second RRM report format for RRM measurements of discovery signals matching the discovery signal candidates that are not part of the first subset.

(13) A mobile station device according to another aspect of the present invention is constituted such that the mobile station device above further comprises a circuit to compare the RRM measurement values of the detected discovery signals, wherein the mobile station device prepares only the first or the second RRM report format based on the discovery signal candidate the detected discovery signal with the largest RRM measurement value matches with.

(14) A mobile station device according to another aspect of the present invention is constituted such that, in the mobile station device above, a non-transitory computer-readable medium comprises computer-executable instructions for causing one or more processors and/or memory to perform the communication method described above.

(15) According to one embodiment of the present invention, there is provided a base station device comprising a first circuit configured with a plurality of discovery signal candidates; and a second circuit adapted to select a discovery signal candidate according to a set of configured conditions; and a third circuit adapted to prepare and transmit the selected discovery signal candidate.

(16) A base station device according to another aspect of the present invention is constituted such that, in the base station device above, the discovery signal candidates differ between them in the combination of reference signals they are configured with, a first discovery signal candidate being based on a combination of reference signals; and a second discovery signal candidate being based on a different combination of reference signals; and subsequently configured discovery signal candidates being based on a combination of reference signals that is different from the combination of reference signals of the previously configured discovery signal candidates.

(17) A base station device according to another aspect of the present invention is constituted such that, in the base station device above, the discovery signal candidates differ between them in the subset of subframes within the discovery signal burst they are transmitted on, a first discovery signal candidate being transmitted on a subset of subframes; and a second discovery signal candidate being transmitted on a different subset of subframes; and subsequently configured discovery signal candidates being transmitted on a subset of subframes that is different from the subset of subframes of the previously configured discovery signal candidates.

(18) A base station device according to another aspect of the present invention is constituted such that, in the base station device above, the discovery signal candidates differ between them in the subset of resource elements within the physical resource block they are transmitted on, a first discovery signal candidate being transmitted on a subset of resource elements; and a second discovery signal candidate being transmitted on a different subset of resource elements; and subsequently configured discovery signal candidates being transmitted on a subset of resource elements that is different from the subset of resource elements of the previously configured discovery signal candidates.

(19) A base station device according to another aspect of the present invention is constituted such that, in the base station device above, the discovery signal candidates differ between them in the transmission power used for their transmission, a first discovery signal candidate being transmitted with a given transmission power; and a second discovery signal candidate being transmitted with a different transmission power; and subsequently configured discovery signal candidates being transmitted with a transmission power that is different from the transmission power of the previously configured discovery signal candidates.

(20) A base station device according to another aspect of the present invention is constituted such that, in the base station device above, the discovery signal candidates differ between them in the period they are transmitted with, the period being a multiple of the period of the discovery signal burst, a first discovery signal candidate being transmitted with a given period; and a second discovery signal candidate being transmitted with a different period; and subsequently configured discovery signal candidates being transmitted with a period that is different from the period of the previously configured discovery signal candidates.

(21) A base station device according to another aspect of the present invention is constituted such that, in the base station device above, a non-transitory computer-readable medium comprises computer-executable instructions for causing one or more processors and/or memory to perform the communication method described above.

### Advantageous Effects of Invention

According to the present invention, a mobile station device is capable of detecting the presence of a dormant cell and roughly discern between different states the dormant cell may be in.

### BRIEF DESCRIPTION OF DRAWINGS

FIG. 1 is a conceptual diagram of a wireless communication system according to the first embodiment.

FIG. 2 is a diagram illustrating an example of a downlink OFDM structure construction according to the present invention.

FIG. 3 is a diagram illustrating an example of a legacy physical resource block with some of its defined reference signals according to the present invention.

FIG. 4 is a diagram illustrating an example of a legacy physical resource block with positioning reference signals (PRS) according to the present invention.

FIG. 5 is a diagram illustrating an example of a downlink OFDM structure construction with primary and synchronization signals according to the present invention.

FIG. 6 is a diagram illustrating an example of an uplink OFDM structure construction according to the present invention.

FIG. 7 is a diagram illustrating the allocation of physical uplink resources to PUCCH and PUSCH according to the present invention.

FIG. 8 is a diagram illustrating an example of the configuration of radio frames in a TDD wireless communication system according to the present invention.

FIG. 9 is a table illustrating the uplink-downlink configurations that are possible in a TDD wireless communication system according to the present invention.

FIG. 10 is a diagram illustrating an example of mobile station device composition according to the present invention.

FIG. 11 is a diagram illustrating an example of base station device composition according to the present invention.

FIG. 12 is a table illustrating an example of UE-specific and common search space configuration for PDCCH in a wireless communication system according to the present invention.

FIG. 13 is a diagram illustrating an example of mapping of a physical EPDCCH-PRB-set to its logical ECCEs according to the present invention.

FIG. 14 is a table illustrating an example of UE-specific search space configuration for ePDCCH in a wireless communication system according to the present invention.

FIG. 15 is a diagram illustrating an example of cell aggregation processing according to the present invention.

FIG. 16 is a diagram illustrating an example of a TDD-FDD aggregated wireless communications system according to the present invention.

FIG. 17 is an exemplary information element that can be used for explicit indication of the discovery signal configuration according to the present invention.

FIG. 18 is a flow chart diagram describing the process by which a mobile station device educes the dormant cell on/off assumptions for a serving cell whose discovery signal has been detected according to the present invention.

### DESCRIPTION OF EMBODIMENTS

Hereinafter, an embodiment of the present invention will be described in detail with reference to the drawings. First, physical channels according to the present invention will be described.

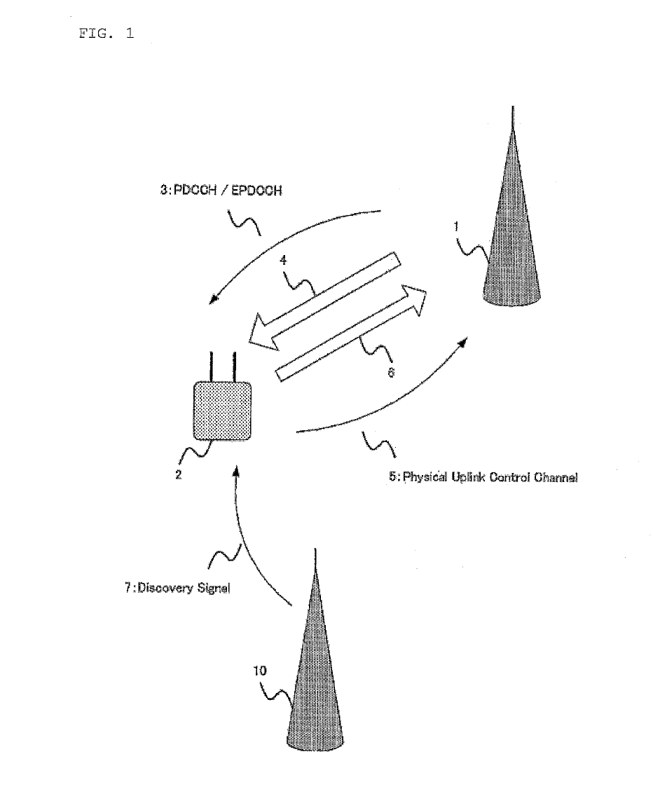

FIG. 1 shows an illustrative communications system. Base station device 1 transmits control information to mobile station device 2 through Physical Downlink Control Channel (PDCCH) or Enhanced PDCCH (ePDCCH) 3. This control information governs the downlink transmission of data 4 and the uplink transmission of data 6.

The information message transmitted in the PDCCH and in the ePDCCH is scrambled with one of many RNTI (Radio Network Temporary Identifier). The used scrambling code helps to differentiate the function of the message, for example, there is an RNTI for paging (P-RNTI), random access (RA-RNTI), cell related operations such as scheduling (C-RNTI), semi-persistent scheduling (SPS-RNTI), system information (SI-RNTI), etc.

The base station device 1 and the mobile station device 2 communicate with each other according to a series of pre-defined parameters and assumptions corresponding to a selected transmission mode (TM). Transmission modes 1 to 10 have been defined to present a plurality of options covering different scenarios and use cases. For example, TM 1 corresponds to single antenna transmission, TM 2 to transmit diversity, TM 3 to open-loop spatial multiplexing, TM 4 to closed-loop spatial multiplexing, TM 5 to multi-user MIMO (Multiple Input Multiple Output), TM 6 to single layer codebook-based precoding, TM 7 to single-layer transmission using DM-RS, TM 8 to dual-layer transmission using DM-RS, TM 9 to multi-layer transmission using DM-RS, and TM 10 to eight layer transmission using DM-RS.

For a given serving cell, if the mobile station device is configured to receive PDSCH data transmissions according to transmission modes 1-9, if the mobile station device is configured with a higher layer parameter epdcch-StartSymbol-r11 the starting OFDM symbol “I_{EPDCCHstart}” for EPDCCH is determined by this parameter. Otherwise, the starting OFDM symbol for EPDCCH1 “I_{EPDCCHstart}” is given by the CFI (Control Format Indicator) present in the PCFICH (Physical Control Format Indicator Channel) present in the PDCCH region when there are more than ten resource blocks present in the bandwidth, and “I_{EPDCCHstart}” is given by the CFI value +1 in the subframe of the given serving cell when there are ten or fewer resource blocks present in the bandwidth.

For a given serving cell, if the UE is configured via higher layer signalling to receive PDSCH data transmissions according to transmission mode 10, for each EPDCCH-PRB-set, the starting OFDM symbol for monitoring EPDCCH in subframe “k” is determined from the higher layer parameter pdsch-Start-r11 as follows:

If the value of the parameter pdsch-Start-r11 is 1, 2, 3 or 4 “I_{EPDCCHstart}” is given by that parameter.

Otherwise, “I_{EPDCCHstart}” is given by the CFI value in subframe “k” of the given serving cell when there are more than ten resource blocks present in the bandwidth, and “I_{EPDCCHstart}” is given by the CFI value +1 in subframe “k” of the given serving cell when there are ten or fewer resource blocks present in the bandwidth.

If subframe “k” is indicated by the higher layer parameter mbsfn-SubframeConfigList-r11 or if subframe “k” is subframe 1 or 6 for TDD operation “I_{EPDCCHstart}=min(2, “I_{EPDCCHstart}”)

Otherwise “I_{EPDCCHstart}”=“I_{EPDCCHstart}”.

Different TMs are transmitted in different antenna ports. Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, and average delay. A mobile station device does not assume that two antenna ports are quasi co-located unless specified otherwise by the base station device.

A mobile station device configured in transmission mode 10 for a serving cell is configured with one of two quasi co-location types for the serving cell by higher layer parameter qcl-Operation to decode the PDSCH or the ePDCCH.

Type A: the mobile station device may assume the antenna ports 0-3 (corresponding to CRS), 7-22 (UE-specific RS and CSI-RS), and 107-110 (corresponding to DM-RS associated with ePDCCH) of a serving cell are quasi co-located with respect to delay spread, Doppler spread, Doppler shift, and average delay.

Type B: the mobile station device may assume the antenna ports 15-22 (corresponding to CSI-RS resource configuration identified by the higher layer parameter qcl-CSI-RS-ConfigNZPId-r11), the antenna ports 7-14 (UE-specific RS), and the antenna ports 107-110 (corresponding to DM-RS associated with ePDCCH) are quasi co-located with respect to delay spread, Doppler spread, Doppler shift, and average delay.

A mobile station configured in transmission mode 10 for a given serving cell can be configured with up to 4 parameter sets by the base station device to decode PDSCH or ePDCCH. The mobile station device uses the parameter set according to the value of the “PDSCH RE Mapping and Quasi-Co-Location Indicator” field (PQI) for determining the PDSCH/ePDCCH RE mapping and for determining the antenna port quasi co-location if the mobile station is configured with Type B quasi co-location type. PQI acts as an index for the 4 configurable parameter sets.

The parameter set referenced by PQI includes crs-PortsCount-r11 (number of antenna ports), crs-FreqShift-r11 (frequency shift of the CRS), mbsfn-SubframeConfigList-r11 (definition of the subframes that are reserved for MBSFN in downlink), csi-RS-ConfigZPId-r11 (identification of a CSI-RS resource configuration for which the mobile station device assumes zero transmission power), pdsch-Start-r11 (starting OFDM symbol) and qcl-CSI-RS-ConfigNZPId-r11 (CSI-RS resource that is quasi co-located with the PDSCH/ePDCCH antenna ports).

In a typical network the coverage of multiple base station devices overlaps in some areas. A system may allow for a mobile station device to be served by any of these base station devices in a transparent way, without the need for the mobile station device to perform a handover to a base station device prior to receiving from it. The base station device in the serving cell configures through RRC messages the quasi co-location parameter set that matches the conditions of the overlapping base station devices. The overlapping base station devices can transmit to the mobile station device with no interruption of service if the mobile station device switches to the right PQI parameter set.

Base station device 10 is in a dormant state. In the dormant state, base station device 10 does not transmit signals normally. At some given times base station device 10 broadcasts a signal intended to let nearby mobile station devices discover the presence of base station device 10 (hereon referred to as “discovery signal” or “DS”, Discovery Signal 7 in the figure). Mobile station device 2 is configured to listen to potential discovery signals and perform RRM (Radio Resource Management) measurements (e.g. RSRP (Reference Signal Received Power) or RSRQ (Reference Signal Received Quality)).

Reference signal received power (RSRP), is defined as the linear average over the power contributions (in [W]) of the resource elements that carry discovery signal reference signals within the considered measurement frequency bandwidth. For RSRP determination the discovery signal specific RS shall be used (e.g. PSS, SSS, CRS, CSI-RS, PRS, etc.). The reference point for the RSRP shall be the antenna connector of the UE. If receiver diversity is in use by the UE, the reported value shall not be lower than the corresponding RSRP of any of the individual diversity branches.

Reference Signal Received Quality (RSRQ) is defined as the ratio N*RSRP/(E-UTRA carrier RSSI), where N is the number of RB's of the E-UTRA carrier RSSI measurement bandwidth. The measurements in the numerator and de-nominator shall be made over the same set of resource blocks. E-UTRA Carrier Received Signal Strength Indicator (RSSI), comprises the linear average of the total received power (in [W]) observed only in OFDM symbols containing reference symbols, in the measurement bandwidth, over N number of resource blocks by the UE from all sources, including co-channel serving and non-serving cells, adjacent channel interference, thermal noise etc. If higher-layer signalling indicates certain subframes for performing RSRQ measurements, then RSSI is measured over all OFDM symbols in the indicated subframes. The reference point for the RSRQ shall be the antenna connector of the UE. If receiver diversity is in use by the UE, the reported value shall not be lower than the corresponding RSRQ of any of the individual diversity branches.

Base station device 10 is expected to broadcast the discovery signal at some predefined instants. For example, base station device 10 broadcasts the discovery signal in one or more of a group of L subframes (“burst”, or “discovery burst”) that occur with a period of M subframes. Mobile station device 2 is configured to monitor for discovery signals in some or all of the L subframes of some or all bursts.

Mobile station device 2 considers a dormant cell successfully detected when the measured RRM of the discovery signal is equal to or exceeds a configured threshold or meets certain conditions. Mobile station device 2 may report the results of the measurements to base station device 1, which may trigger base station device 1 to activate base station device 10 (herein after also referred to as wake up or turn on)

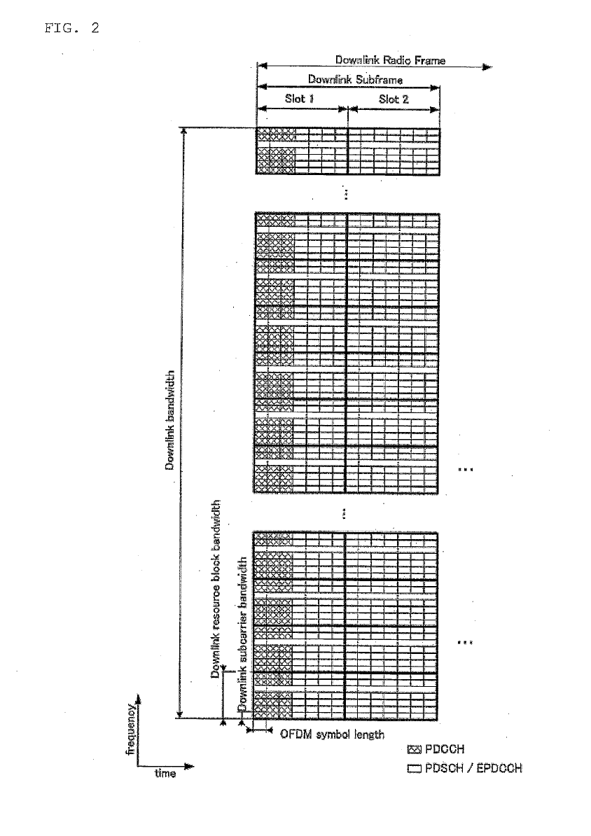

FIG. 2 illustrates a construction example of a downlink subframe. The downlink transmission is performed through OFDMA. A downlink subframe has a length of 1 ms, and can be broadly thought of as divided into PDCCH, ePDCCH and PDSCH. Each subframe is composed of two slots. Each slot has a length of 0.5 ms. A slot is further divided into a plurality of OFDM symbols in the time domain, each one of them being composed of a plurality of subcarriers in the frequency domain. In an LTE system one RB includes twelve subcarriers and seven (or six) OFDM symbols. Each subcarrier of each OFDM symbol is a Resource Element (RE). The grouping of all the REs present in a slot composes a Resource Block (RB). The grouping of the two physically consecutive resource blocks present in a subframe composes a Physical Resource Block pair (PRB pair). A PRB pair (2 slots) comprises 12 subcarriers×14 OFDM symbols in the case of normal CP (cyclic prefix), and 12 subcarriers×12 OFDM symbols in the case of extended CP. The PDCCH region occupies the REs of the first 1 to 4 OFDM symbols of the frame.

The PDCCH region of a PRB pair spans the first 1, 2, 3 or 4 OFDM symbols. The rest of the OFDM symbols are used as the data region (PDSCH, Physical Downlink Shared channel). The PDCCH is sent in the antenna ports 0-3, along with the CRS.

The CRS are allocated to REs across the PRB according to a pattern that is independent of the length of the PDCCH region and the data region. The number of CRS in a PRB depends on the number of antennas that are configured for the transmission.

The Physical Control Format Indicator Channel (PCFICH) is allocated in the first OFDM symbol to REs that are not allocated to CRS. The PCFICH is composed of 4 Resource Element Group (REG), each REG being composed of 4 REs. It contains a value from 1 to 3 (or 2 to 4 depending on the bandwidth), corresponding to the length of the physical downlink control channel (PDCCH).

The Physical Hybrid-ARQ Indicator Channel (PHICH, where ARQ stands for Automatic Repeat-reQuest) is allocated in the first symbol to REs that are not allocated to CRS or PCFICH. It transmits the HARQ ACK/NACK signals for uplink transmission. The PHICH is composed of 1 REG, and is scrambled in a cell-specific manner. A plurality of PHICHs can be multiplexed in the same REs and conform a PHICH group. A PHICH group is repeated 3 times to obtain diversity gain in the frequency and/or time region.

The PDCCH is allocated in the first ‘n’ OFDM symbols (where ‘n’ is indicated by the PCFICH). The PDCCH contains the Downlink Control Information (DCI) messages, which may contain downlink and uplink scheduling information, downlink ACK/NACK, power control information, etc. The DCI is carried by a plurality of Control Channel Elements (CCE). A CCE is composed of 4 consecutive REs in the same OFDM symbol that are not occupied by CRS, the PCFICH, or the PHICH.

The CCEs are numbered starting from 0 in ascending order first of frequency and second of time. First the lowest frequency RE in the first OFDM symbol is considered. If that RE is not occupied by other CCE, CRS, PHICH, or PCFICH, it is numbered. Otherwise the same RE corresponding to the next OFDM symbol is evaluated. Once all OFDM symbols have been considered the process is repeated for all REs in frequency order.

The REs that are not occupied by a reference signal in the data region can be allocated to ePDCCH or Physical Downlink Shared Channel (PDCCH).

The UE monitors a set of PDCCH candidates, where monitoring implies attempting to decode each of the PDCCHs in the set according to all monitored DCI formats. The set of PDCCH candidates to monitor are defined in terms of Search Spaces (SS), where a search space “Sₖ^{(L)}”at a given aggregation level L is defined by a set of PDCCH candidates.

Each UE monitors two search spaces, the UE-specific Search Space (USS) and the

Common Search Space (CSS). The USS carries information that is directed exclusively to the UE, therefore only the pertinent UE can decode it. The USS is different for each UE. USS of two or more mobile station devices can be partially overlapped. The CSS contains general information that is directed to all UEs. All UEs monitor the same common search space and are able to decode the information therein.

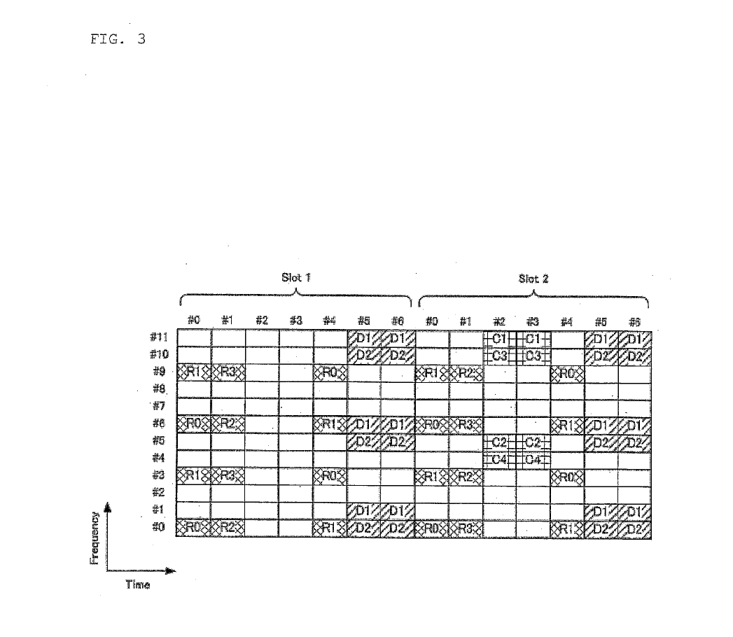

FIG. 3 illustrates an example downlink PRB. Some of the REs of the PRB are occupied by reference signals. The different reference signals are associated to different antenna ports. The term “antenna port” is used to convey the meaning of signal transmission under identical channel conditions. For example, signals sent in the antenna port 0 suffer the same channel conditions, which may differ from those of antenna port 1.

R0-R3 correspond to Cell-specific RS (CRS), which are sent in the same antenna ports as the PDCCH (antenna ports 0-3) and are used to demodulate the data transmitted in the PDCCH, and also to demodulate the data transmitted in the PDSCH in some transmission modes (TM). In order to avoid excessive interference to neighboring cells interference cancellation procedures can be implemented.

D1-D2 correspond to DM-RS associated with ePDCCH. They are sent in the antenna ports 107-110 and serve as demodulation reference signal for the mobile station device to demodulate the ePDCCH therein. The UE-specific reference signals are transmitted in the same REs when configured (not at the same time). The UE-specific reference signals are transmitted in ports 7-14 and serve as demodulation reference signal for the mobile station device to demodulate the PDSCH therein.

C1-C4 correspond to CSI-RS (Channel State Information RS). They are sent in the antenna ports 15-22 and enable the mobile station device to measure the channel conditions.

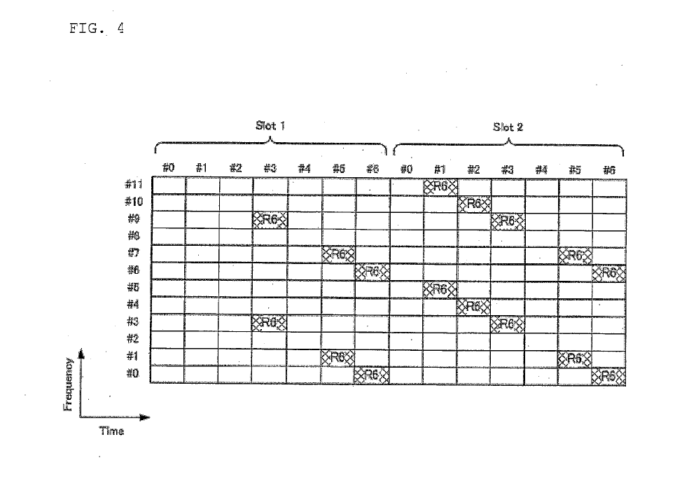

FIG. 4 illustrates an example downlink PRB. In this example, the REs of the PRB marked as R6 are occupied by positioning reference signals (PRS). The positioning reference signals are associated to antenna port 6. They serve to support location services, and are usually only present in PRBs designated specifically for PRS.

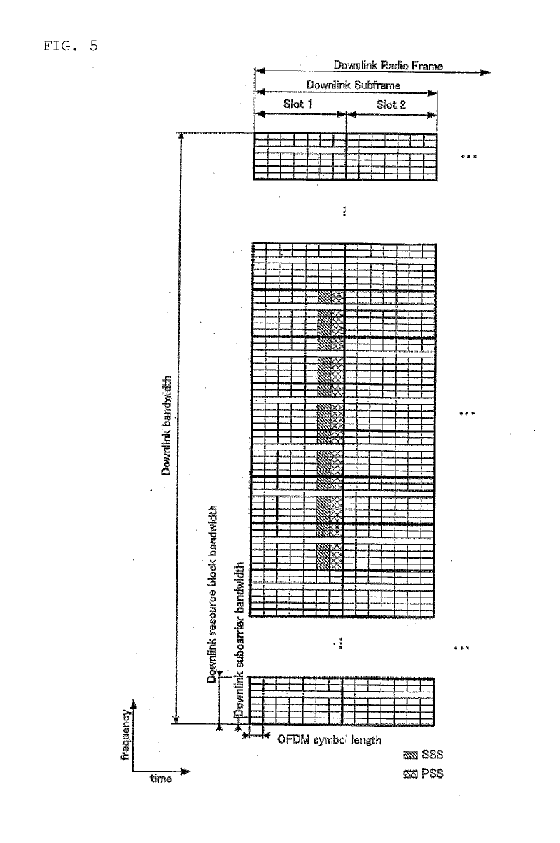

FIG. 5 illustrates a construction example of an FDD downlink subframe with a primary synchronization signal (PSS) and a secondary synchronization signal (SSS). The pair of PSS and SSS may be herein after referred to as PSS/SSS. The PSS occupies the REs in the OFDM symbol #6 of the central 6 PRBs of the bandwidth, and the SSS occupies the REs in the OFDM symbol #5 of the central 6 PRBs of the bandwidth. Mobile station devices detect the PSS by blindly correlating the signal with 3 possible PSS signals. Once a PSS is detected the mobile station device gains rough synchronization with the base station device and is able to perform channel estimation to decode SSS. The mobile station device can obtain the ID of the cell and more accurate synchronization via the SSS.

The discovery signal (DS) can be constructed as a combination of PSS, SSS, and another one or more reference signals, such as CRS, CSI-RS, or PRS. The location of the PSS and SSS signals used for this purpose can be the same as for FDD or may be different. Alternatively, the discovery signal can be constructed using exclusively the synchronization pair PSS/SSS. A mobile station device detecting a discovery signal in a discovery burst proceeds to measure its RSRP or RSRQ as configured by the base station device.

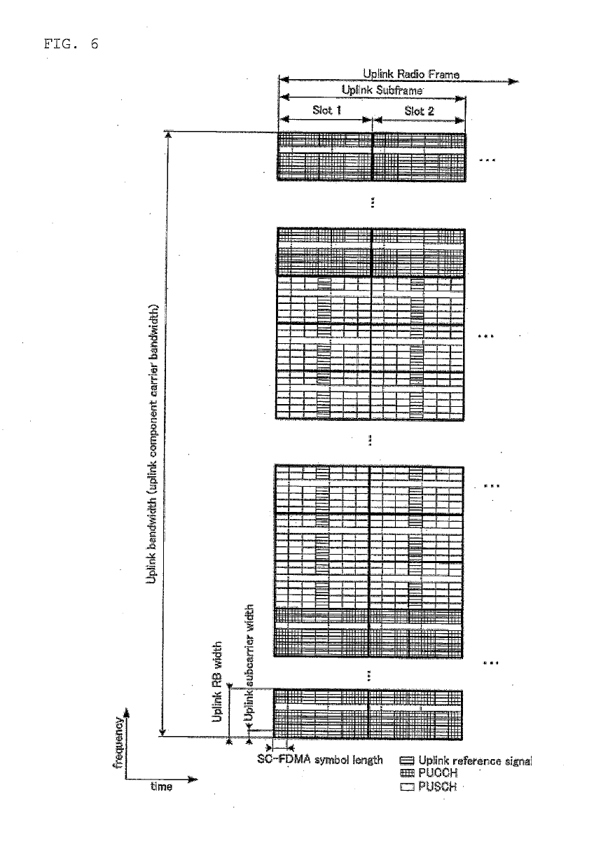

FIG. 6 illustrates a construction example of an uplink subframe. The uplink transmission is performed through SC-FDMA (Single Carrier Frequency Division Multiple Access). The uplink resources are allocated to physical channels such as the PUSCH (Physical Uplink Shared Channel) and the PUCCH (Physical Uplink Control Channel). In addition, uplink reference signals are transmitted in part of the resources that would correspond to the PDSCH and the PUCCH. An uplink wireless frame is composed of PRB pairs. The PRB pair is the basic schedulable circuit, with a predefined frequency width (the width of a resource block) and time length (2 slots=1 subframe).

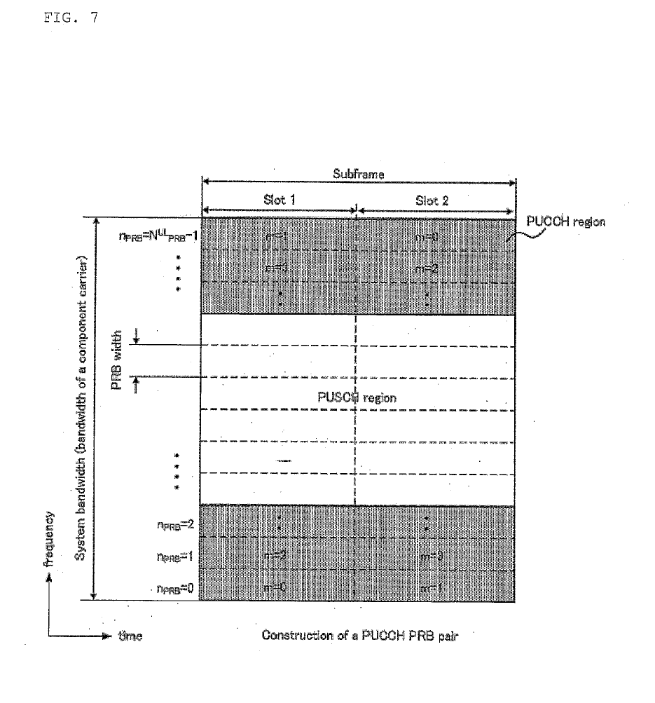

FIG. 7 illustrates the allocation of physical uplink resources to PUCCH and PUSCH. The PUCCH PRB pairs consist of two slots with different frequency allocations. The PUCCH element “m” is allocated to the PUCCH PRB pair with index “m”, where “m”=0, 1, 2, 3 . . . .

The transmission of data in LTE can be done through frame structure type 1 (FDD) and/or through frame structure type 2 (TDD).

For FDD, 10 subframes are available for downlink transmission and 10 subframes are available for uplink transmissions in each radio frame. Uplink and downlink transmissions are separated in the frequency domain. In half-duplex FDD operation, the UE cannot transmit and receive at the same time, while there are no such restrictions in full-duplex FDD.

A mobile station device connected to an FDD base station device receives in a subframe “n” a PDCCH message indicating the scheduling of a downlink PDSCH. The PDCCH message contains among other information the PRBs in which the PDSCH is located and the HARQ process number assigned to it. The mobile station device attempts to decode it and, following the FDD HARQ timing, sends an HARQ ACK/NACK indication to the base station device in the subframe “n+4” indicating that the reception was successful (ACK) or failed (NACK). If the base station device receives an HARQ-ACK indication, the base station device releases the HARQ process number, which can then be used for a subsequent PDSCH. Otherwise, if the base station receives an HARQ-NACK indication (or no indication) the base station device will attempt to transmit the PDSCH to the mobile station device again in the subframe “n+8”. The retransmitted message keeps the same HARQ process number, allowing the mobile station device to combine the new retransmission with the previous received data to increase the likelihood of a successful reception. Therefore, for FDD, there shall be a maximum of 8 downlink HARQ processes per serving cell.

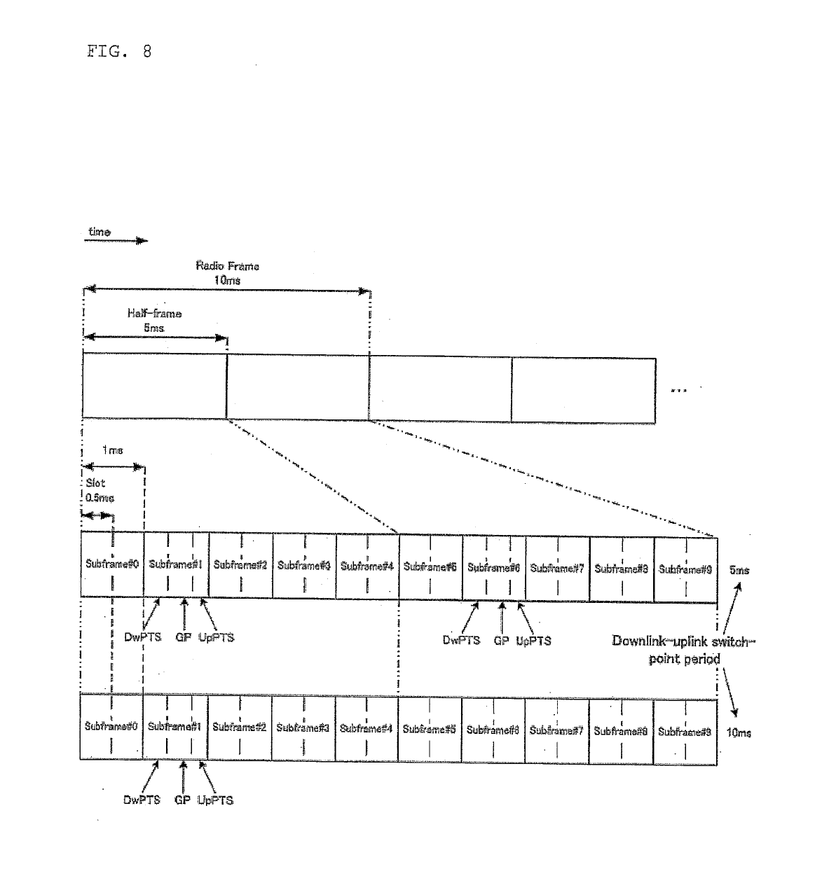

FIG. 8 illustrates the composition of an LTE radio frame in the Time Division Duplex mode (TDD).

An LTE radio frame has a length of 10 ms, and is composed of 10 subframes.

Each subframe can be used for downlink or uplink communication as configured by the eNB. The switch from downlink to uplink transmission is performed through a special subframe that acts as switch-point. Depending on the configuration a radio frame can have 1 special subframe (switch-point periodicity of 10 ms) or 2 special subframes (switch-point periodicity of 5 ms).

In most cases subframes #1 and #7 are the “special subframe”, and include the three fields DwPTS (Downlink Pilot Time Slot), GP (Guard Period) and UpPTS (Uplink Pilot Time Slot). DwPTS spans a plurality of OFDM symbols and is dedicated to downlink transmission. GP spans a plurality of OFDM symbols and is empty. GP is longer or shorter depending on the system conditions to allow for a smooth transition between downlink and uplink UpPTS spans a plurality of OFDM symbols and is dedicated to uplink transmission. DwPTS carries the Primary Synchronization Signal (PSS). Subframes #0 and #5 carry the Secondary Synchronization Signal (SSS), and therefore cannot be configured for uplink transmission. Subframe #2 is always configured for uplink transmission.

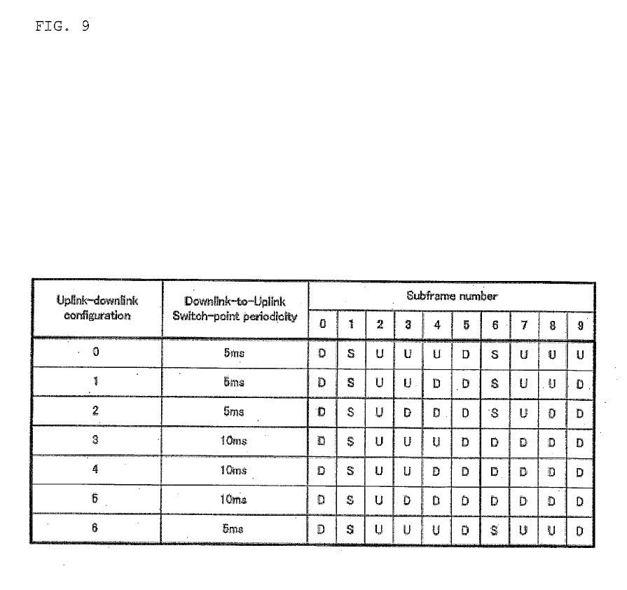

FIG. 9 lists the possible Uplink-Downlink configurations, where “U” denotes that the subframe is reserved for uplink transmission, “D” denotes that the subframe is reserved for downlink transmission, and “S” denotes the special subframe. The base station device transmits to the mobile station device the index of the Uplink-Downlink configuration to be used.

The base station device can transmit a second Uplink-Downlink configuration index.

The subframes in which both Uplink-Downlink have the same configuration are handled as described above (they are indistinctly referred to as legacy subframes in the rest of the documents). The subframes in which both Uplink-Downlink configurations differ are flexible subframes, which are subframes that can be used for either uplink or downlink For example, Uplink-Downlink configuration 1 is configured as U, while Uplink-Downlink configuration 2 is configured as D or S.

Even though uplink-downlink configuration 0 through 6 as currently defined are shown in the figure, any embodiment of this invention is also applicable to a potential new uplink-downlink configuration. For example, a new uplink-downlink configuration in which all the subframes are defined as downlink could be introduced and it would be readily applicable to any embodiment of the present invention. Another example would be a new uplink-downlink configuration in which all the subframes are defined as downlink with the exception of subframe #1, which is defined as a special subframe. The exemplary new uplink-downlink configuration could be named uplink-downlink configuration 7, or it may be given a distinctly different name to help differentiate it from the other uplink-downlink configurations. In the rest of the document there are instances in which a reference is made to a range of uplink-downlink configurations. In those cases a potential new uplink-downlink configuration as described above is not precluded from being part of the range. For example, the expression “uplink-downlink configuration 1-6” is equivalent in most cases to “uplink-downlink configuration 1-7”.

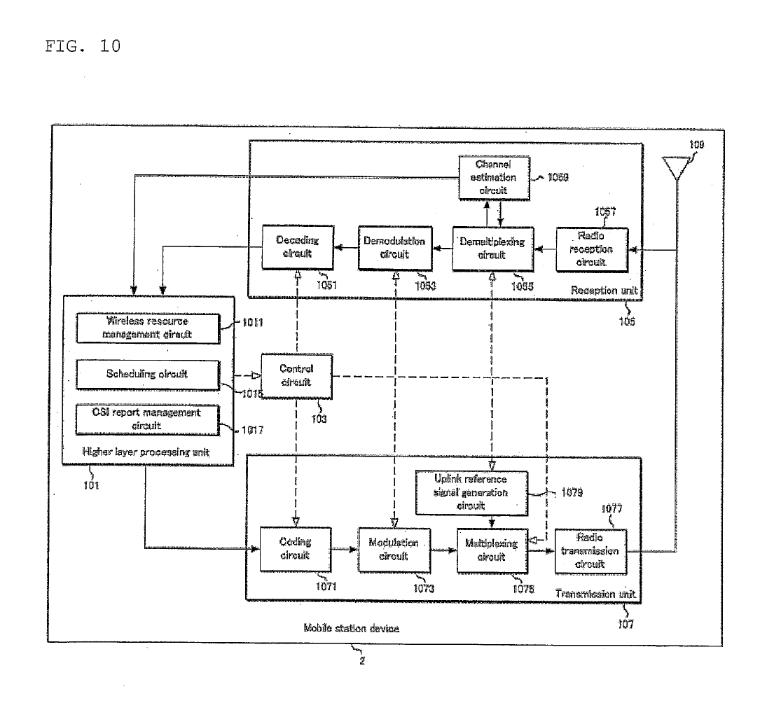

FIG. 10 illustrates the block diagram of a mobile station device that corresponds with the mobile station device 2. As shown in the figure, the mobile station device includes a higher layer processing circuit 101, a control circuit 103, a reception circuit 105, a transmission circuit 107, and an antenna circuit 109. The higher layer processing circuit 101 supports being configured with more than one cell, one of them as a primary cell and the rest of the cells as secondary cells, and includes a wireless resource management circuit 1011, a scheduling circuit 1015, and a CSI report management circuit 1017. The reception circuit 105 includes a decoding circuit 1051, a demodulation circuit 1053, a demultiplexing circuit 1055, a radio reception circuit 1057, and a channel estimation circuit 1059. The transmission circuit 107 includes a coding circuit 1071, a modulation circuit 1073, a multiplexing circuit 1075, a radio transmission circuit 1077, and an uplink reference signal creation generation 1079.

The higher layer processing circuit 101 generates control signal to control the operation of the reception circuit 105 and the transmission circuit 107 and outputs them to control circuit 103. In addition, the upper layer processing circuit 101 processes the operations related to the MAC layer (Medium Access Control), the PDCP layer (Packet Data Convergence Protocol), the RLC layer (Radio Link Control), and the RRC layer (Radio Resource Control).

The wireless resource management circuit 1011 in the higher layer processing circuit 101 manages the configuration related to its own operation. In addition, the wireless resource management circuit generates the data that is transmitted in each channel and outputs this information to the transmission circuit 107.

The scheduling circuit 1015 in the higher layer processing circuit 101 reads the scheduling information contained in the DCI messages received via the reception circuit 105 and outputs control information to control circuit 103, which in turn sends control information to reception circuit 105 and transmission circuit 107 to perform the required operations.

In addition, the scheduling circuit 1015 decides the transmission processing and the reception processing timing based on the uplink reference configuration, the downlink reference configuration and/or the transmission direction configuration.

The CSI report management circuit 1017 in the higher layer processing circuit 101 identifies the CSI reference REs. The CSI report management circuit 1017 requests channel estimation circuit 1059 to derive the channel's CQI (Channel Quality Information) from the CSI references REs. The CSI report management circuit 1017 outputs the CQI to the transmission circuit 107. The CSI report management circuit 1017 sets the configuration of the channel estimation circuit 1059.

Control circuit 103 generates control signals addressed to reception circuit 105 and transmission circuit 107 based on the control information received from higher layer processing circuit 101. Control circuit 103 controls the operation of reception circuit 105 and transmission circuit 107 through the generated control signals.

Reception circuit 105, according to the control information received from control circuit 103, receives information from the base station device 1 via the antenna circuit 109 and performs demultiplexing, demodulation and decoding to it. Reception circuit 105 outputs the result of these operations to higher layer processing circuit 101.

The radio reception circuit 1057 down-converts the downlink information received from the base station device 1 via the antenna circuit 109, eliminates the unnecessary frequency components, performs amplification to bring the signal to an adequate level, and based on the in-phase and quadrature components of the received signal transforms the received analog signal into a digital signal. The radio reception circuit 1057 trims the guard interval (GI) from the digital signal and performs FFT (Fast Fourier Transform) to extract the frequency domain signal.

The demultiplexing circuit 1055 demultiplexes the PHICH, the PDCCH, the ePDCCH, the PDSCH, and the downlink reference signals from the extracted frequency domain signal. In addition, the demultiplexing circuit 1055 performs channel compensation to the PHICH, PDCCH, ePDCCH, and PDSCH, based on the channel estimation values received from the channel estimation circuit 1059. The demultiplexing circuit 1055 outputs the demultiplexed downlink reference signals to the channel estimation circuit 1059.

The demodulation circuit 1053 performs multiplication by the code corresponding to the PHICH, performs BPSK (Binary Phase Shift Keying) demodulation to the resulting signal, and outputs the result to the decoding circuit 1051. The decoding circuit 1051 decodes the PHICH addressed to the mobile station device 2 and transmits the decoded HARQ indicator to the higher layer processing circuit 101. The demodulation circuit 1053 performs QPSK (Quadrature Phase Shift Keying) demodulation to the PDCCH and/or ePDCCH and outputs the result to the decoding circuit 1051. The decoding circuit 1051 attempts to decode the PDCCH and/or the ePDCCH. If the decoding operation is successful, the decoding circuit 1051 transmits the downlink control information and the corresponding RNTI to the higher layer processing circuit 101.

The demodulation circuit 1053 demodulates the PDSCH addressed to mobile station device 2 as indicated by the downlink control grant indication (QPSK, 16 QAM (Quadrature Amplitude Modulation), 64 QAM, 256 QAM, or other), and outputs the result to the decoding circuit 1051. The decoding circuit 1051 performs decoding as indicated by the downlink control grant indication and outputs the decoded downlink data (transport block) to the higher layer processing circuit 101.

The channel estimation circuit 1059 estimates the pathloss and the channel conditions from the downlink reference signals received from the demultiplexing circuit 1055 and outputs the estimated pathloss and channel conditions to the higher layer processing circuit 101. In addition, the channel estimation circuit 1059 outputs the channel values estimated from the downlink reference signals to the demultiplexing circuit 1055. In order to compute the CQI, the channel estimation circuit 1059 performs measurements to the channel and/or interference.

The transmission circuit 107, according to the control information received from control circuit 103, generates the uplink reference signals, performs coding and modulation to the uplink data received from the higher layer processing circuit (transport block), multiplexes the PUCCH, the PUSCH and the generated uplink reference signals, and transmits it to the base station 1 through the antenna circuit 109.

The coding circuit 1071 performs block coding, convolutional coding, or others, to the uplink control information received from the higher layer processing circuit 101. In addition, the coding circuit 1071 performs turbo coding to the scheduled PUSCH data.

The modulation circuit 1073 performs modulation (BPSK, QPSK, 16 QAM, 64 QAM, 256 QAM, or other) to the coded bitstream received from coding circuit 1071 according to the downlink control indication received from base station device 1 or to a pre-defined modulation convention for each channel. Modulation circuit 1073 decides the number of PUSCH streams to transmit through spatial multiplexing, maps the uplink data to that number of different streams, and performs MIMO SM (Multiple Input Multiple Output Spatial Multiplexing) precoding to those streams.

Uplink reference signal generation circuit 1079 generates a bit stream following a series of pre-defined rules in accordance to the PCI (Physical Cell Identity, or Cell ID) for the base station device 1 to be able to discern the signals sent from the mobile station device 2, the value of the bandwidth in which to place the uplink reference signals, the cyclic shift indicated in the uplink grant, and the value of the parameters related to the DMRS sequence generation. The multiplexing circuit 1075 arranges the PUSCH modulated symbols in different streams and performs DFT (Discrete Fourier Transform) to them according to the indications given by control circuit 103. In addition, the multiplexing circuit 1075 multiplexes the PUCCH, the PUSCH, and the generated reference signals in their corresponding REs in their appropriate antenna ports.

Radio transmission circuit 1077 performs IFFT (Inverse Fast Fourier Transform) to the multiplexed signals, performs SC-FDMA modulation (Single Carrier Frequency Division Multiple Access) to them, adds the GI to the resulting streams, generates the digital baseband signal, transforms the digital baseband signal into an analog baseband signal, generates the in-phase and quadrature components of the analog signal and up-converts it, removes the unnecessary frequency components, performs power amplification, and outputs the resulting signal to antenna circuit 109.

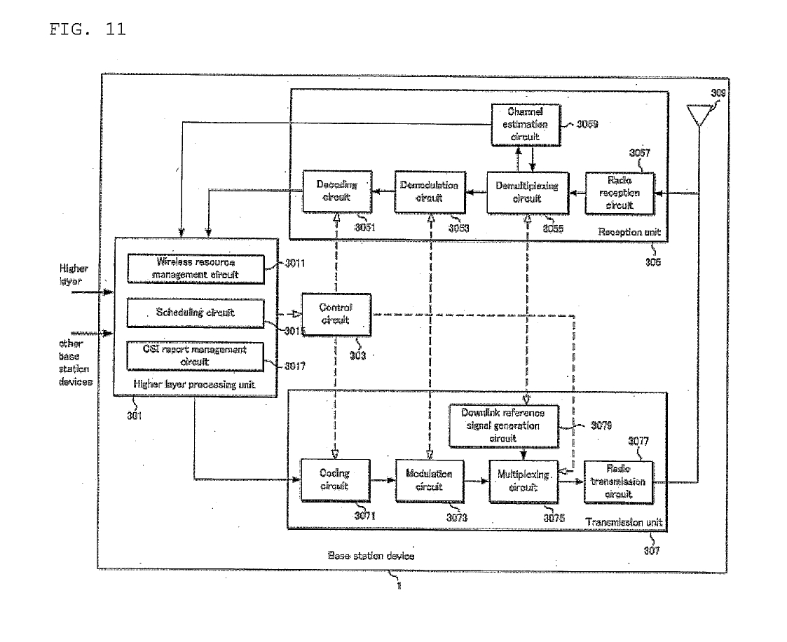

FIG. 11 illustrates the block diagram of a base station device that corresponds with base station devices 1 and 3. As shown in the figure, the mobile station device includes a higher layer processing circuit 301, a control circuit 303, a reception circuit 305, a transmission circuit 307, and an antenna circuit 309. The higher layer processing circuit 301 giving support to one or more cells present in the base station device, and includes a wireless resource management circuit 3011, a scheduling circuit 3015, and a CSI report management circuit 3017. The reception circuit 305 includes a decoding circuit 3051, a demodulation circuit 3053, a demultiplexing circuit 3055, a radio reception circuit 3057, and a channel estimation circuit 3059. The transmission circuit 307 includes a coding circuit 3071, a modulation circuit 3073, a multiplexing circuit 3075, a radio transmission circuit 3077, and a downlink reference signal creation generation 3079.

The higher layer processing circuit 301 generates control signal to control the operation of the reception circuit 305 and the transmission circuit 307 and outputs them to control circuit 303. In addition, the upper layer processing circuit 301 processes the operations related to the MAC layer (Medium Access Control), the PDCP layer (Packet Data Convergence Protocol), the RLC layer (Radio Link Control), and the RRC layer (Radio Resource Control).

The wireless resource management circuit 3011 in the higher layer processing circuit 301 generates the downlink data to transmit in the downlink PDSCH (transport block), the system information, the RRC messages, and the MAC CE (Control Element) and outputs it to the transmission circuit 307. Alternatively, this information can be obtained from a higher layer. In addition, the wireless resource management circuit 3011 manages the configuration information of each mobile station device.

The scheduling circuit 3015 in the higher layer processing circuit 301 decides the frequency and subframe allocation of the physical channels (PDSCH and PUSCH), and their appropriate coding rate, modulation and transmission power according to the channel condition report received from the mobile station 2 and the channel estimation and channel quality parameters received from channel estimation circuit 3059. The scheduling circuit 3015 generates control signals (for example, with the DCI format (Downlink Control Information)) to control the reception circuit 305 and the transmission circuit 307 based on the resulting scheduling and outputs them to the control circuit 303.

The scheduling circuit 3015 generates the report that carries the scheduling information for the physical channels (PDSCH and PUSCH) based on the resulting scheduling.

The CSI report management circuit 3017 in the higher layer processing 301 controls the CSI report of the mobile station device 2. The CSI report management circuit 3017 transmits to the mobile station device 2 the configuration information for deriving the CQI from the CSI reference signal REs via the antenna circuit 309.

Control circuit 303 generates the control signals to manage the reception circuit 305 and the transmission circuit 307 according to the control signals received from the higher layer processing circuit 301. Control circuit 303 outputs these signals to the reception circuit 305 and the transmission circuit 307 and controls their operation.

Reception circuit 305, according to the control information received from control circuit 303, receives information from the mobile station device 2 via the antenna circuit 309 and performs demultiplexing, demodulation and decoding to it. Reception circuit 305 outputs the result of these operations to higher layer processing circuit 3101.

The radio reception circuit 3057 down-converts the downlink information received from the mobile station device 2 via the antenna circuit 309, eliminates the unnecessary frequency components, performs amplification to bring the signal to an adequate level, and based on the in-phase and quadrature components of the received signal transforms the received analog signal into a digital signal. The radio reception circuit 3057 trims the guard interval (GI) from the digital signal and performs FFT (Fast Fourier Transform) to extract the frequency domain signal.

The demultiplexing circuit 3055 demultiplexes the PUCCH, the PUSCH and the reference signals of the received signal from the radio reception circuit 3057. This de-multiplexing is performed according to the uplink grant and the wireless resource allocation information sent to the mobile station 2. In addition, the demultiplexing circuit 3055 performs channel compensation of the PUCCH and the PUSCH according to the channel estimation values received from the channel estimation circuit 3059. In addition, the demultiplexing circuit 3055 gives the demultiplexed uplink reference signal to the channel estimation circuit 3059.

The demodulation circuit 3053 performs IDFT (Inverse Discrete Fourier Transform) to the PUSCH, obtains the modulated symbols, and performs demodulation (BPSK, QPSK, 16 QAM, 64 QAM, or other) for each PUCCH and PUSCH symbol according to the modulation configuration transmitted to the mobile station 2 in the uplink grant notification or according to another pre-defined configuration. The demodulation circuit 3053 separates the symbols received in the PUSCH according to the MIMO SM precoding configuration transmitted to the mobile station 2 in the uplink grant notification or according to another pre-defined configuration.

The decoding circuit 3051 decodes the received uplink data in the PUSCCH and the PUSCH according to the coding rate configuration transmitted to the mobile station 2 in the uplink grant notification or according to another pre-defined configuration, and outputs the resulting stream to the higher layer processing circuit 301. In the case of re-transmitted PUSCH the decoding circuit 3051 decodes the received demodulated bits using the coded bits that are held in the HARQ buffer in the higher processing circuit 301. The channel estimation circuit 3059 estimates the channel conditions and the channel quality using the uplink reference signal received from the demultiplexing circuit 3055, and outputs this information to the demultiplexing circuit 3055 and the higher layer process circuit 301.

The transmission circuit 307, according to the control information received from control circuit 303, generates the downlink reference signals, prepares the discovery signal if indicated by control 303, prepares the downlink control information including the HARQ indicator received from the higher layer processing circuit 301, performs coding and modulation of the downlink data, multiplexes the result with the PHICH, the PDCCH, the ePDCCH, the PDSCH and the downlink reference signal, and transmit the resulting signal to the mobile station device 2 via the antenna circuit 309.

The coding circuit 3071 performs block coding, convolutional coding, turbo coding, or other, to the HARQ indicator received from the higher layer processing 301, the downlink control information and the downlink data, according to the coding configuration decided by the wireless resource management circuit 3011 or according to another pre-defined configuration.

The modulation circuit 3073 performs modulation (BPSK, QPSK, 16 QAM, 64 QAM, 256 QAM, or other) to the coded bitstream received from coding circuit 3071 according to the modulation configuration decided by the wireless resource management circuit 3011 or according to another pre-defined configuration.

The downlink reference signal generation circuit 3079 generates downlink reference signals well known by the mobile station device 2 according to some pre-defined rules and employing the PCI (Physical Cell Identity) value, which allows the mobile station device 2 to discern the transmission of the base station device 1. The multiplexing circuit 3075 multiplexes the modulated symbols in each channel and the generated downlink reference signals in their corresponding REs in their appropriate antenna port.

The radio transmission circuit 3077 performs IFFT (Inverse Fast Fourier Transform) to the multiplexed symbols, OFDM modulation, adds the guard interval to the OFDM symbols, generates the digital baseband signal, transforms the digital baseband signal into an analog baseband signal, generates the in-phase and quadrature components of the analog signal and up-converts it, removes the unnecessary frequency components, performs power amplification, and outputs the resulting signal to antenna circuit 309.

The number of available resources for transmission of control or information data depends on the reference signals present in each resource block. The base station device is configured to avoid the transmission of data in these REs by a proper resource element mapping.

The mobile station device assumes the resource element mapping that is used at any given time to retrieve the data. The data is mapped in sequence to REs on the associated antenna port which fulfill that they are part of the EREGs assigned for the EPDCCH transmission, they are assumed by the UE not to be used for CRS or for CSI-RS, and they are located in an OFDM symbol that is equal or higher than the starting OFDM symbol indicated by “I_{EPDCCHstart}”.

In the PDCCH region a CCE is defined to always have 4 available REs to transmit information. In order to do this the CCE configuration presents some variations depending on the number of CRS present or the reach of the PHICH. The result is that the PDCCH messages always have the same number of bits.

However, in the ePDCCH/PDCCH region the number of bits is variable. In order to be able to use all the available REs the base station mobile must accommodate the data to them. This is achieved by rate matching.

The rate matching operation generates a stream of bits of the required size by varying the code rate of the turbo code operation. The rate matching algorithm is capable of producing any arbitrary rate. The bitstreams from the turbo encoder undergo an interleave operation followed by bit collection to create a circular buffer. Bits are selected and pruned from the buffer to create a single bitstream with the desired code rate.

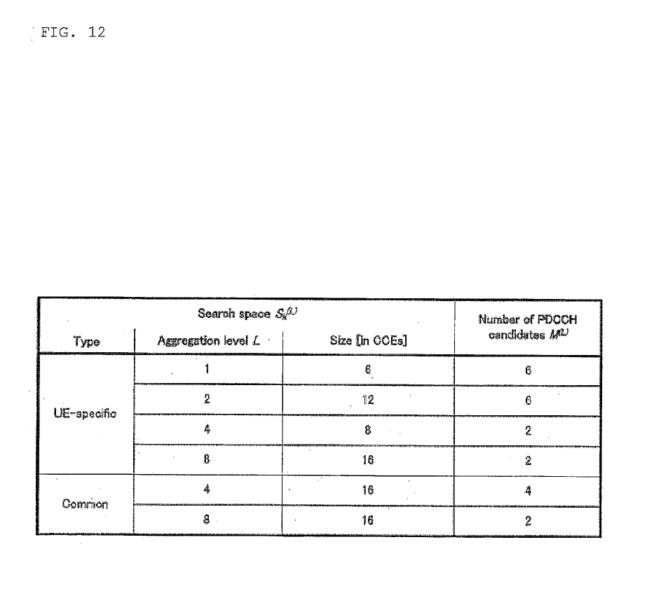

FIG. 12 contains the values that a mobile station device monitors for each aggregation level in the USS and the CSS. The aggregation level is the number of CCEs that a PDCCH uses. The mobile station device monitors a number of PDCCH candidates M(L) for each aggregation level. For the common search space L can take one of two values, L=4 or L=8. The number of candidates the UE monitors is M(L)=4 for L=4 and MN=2 for L=8. The size of the search space of each of the cases is 16 CCEs.

The basic circuit of the Enhanced PDCCH (ePDCCH) is the Enhanced Resource Element Group (EREG). The REs of a PRB pair are cyclically numbered from 0 to 15 in ascending order of frequency and OFDM symbol skipping the REs that may contain DMRS (DeModulation Reference Signals). The same transmission processing that is applied to the PDSCH is applied to the DMRS, which allows the UE to obtain the information it needs to be able to demodulate the data. EREG, is composed of all the REs with number ‘i’, where i=0, 1, . . . 15.

However, the number of REs that can be used is not fixed. The REs used for PDCCH, CRS and CSI-RS (Channel State Information Reference Signal) cannot be used for ePDCCH. The CSI-RS are transmitted periodically to enable the UE to measure the channel conditions of up to 8 antennas, and it is not defined for special subframe configurations.

The control information is transmitted in Enhanced CCEs (ECCEs), which are composed of 4 or 8 EREGs, depending on the number of REs that are available for transmission in each ECCE for a given configuration.

There can be 1 or 2 sets of ePDCCH-sets simultaneously, each one independently configurable and spanning 1, 2, 4 or 8 PRB pairs. The ePDCCH is sent in the antenna ports 107-110, along with the DM-RS.

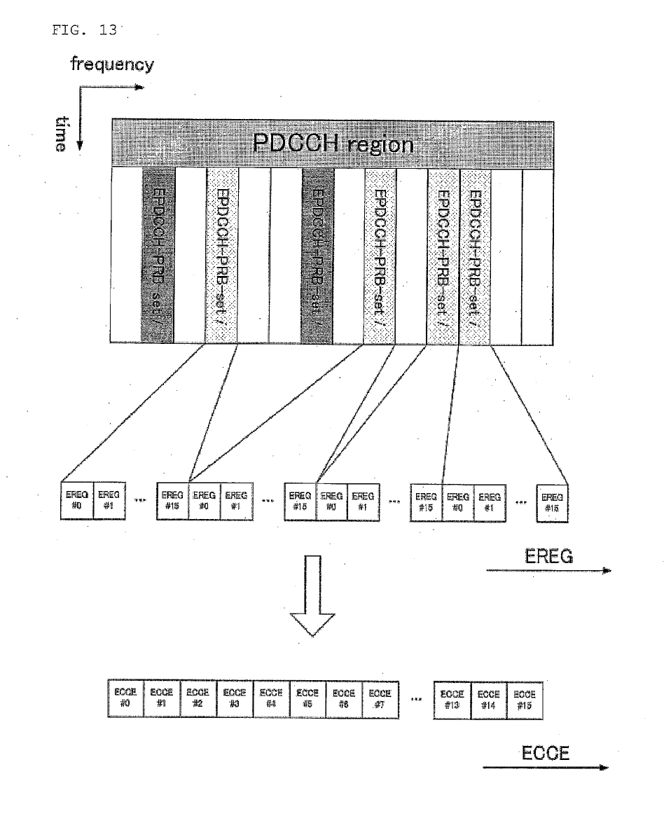

FIG. 13 illustrates the mapping of the ECCEs of the ePDCCH in the PRB-pairs of ePDCCH-set “i” (where “i” is either 0 or 1, and “1” is also either 0 or 1 while fulfilling “1” is not equal to “i”). Each PRB-pair is composed of 16 EREGs. The EREGs of all the PRB-pairs together can be considered as the EREGs of the ePDCCH-set. A PRB pair comprises 16 EREGs, which can compose 4 or 2 ECCEs. In the example of the figure one ECCE is assumed to be composed of 4 EREGs.

In a localized allocation, each ECCE of the ePDCCH is composed of EREGs belonging to a single a PRB pair. Due to all the REGs being in a relatively narrow band, higher benefits can be obtained through precoding and scheduling.

In a distributed allocation, each ECCE of the ePDCCH is composed of EREGs belonging to different PRB pairs. Due to the frequency hopping performed to the REGs, the robustness is increased through frequency diversity.

In consideration to localized or distributed allocation of the control information, ePDCCH set 0 does not condition ePDCCH set 1 (if present). ePDCCH set 0 and ePDCCH set 1 are defined for any combination of localized and/or distributed transmission mapping.

UE-specific search space is defined for ePDCCH as ePDCCH USS (also referred to as eUSS). The search space of each ePDCCH-PRB-set is independently configured.

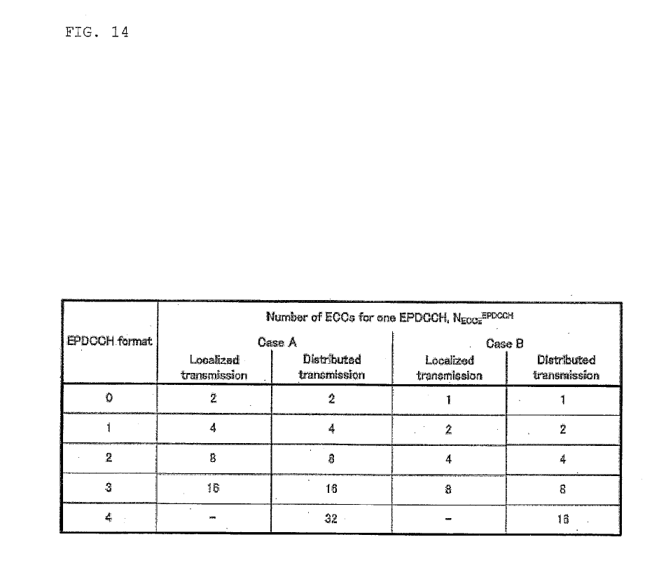

FIG. 14 contains the number of ECCEs that constitute an ePDCCH for each ePDCCH format. Case A applies for normal subframes and normal downlink CP when DCI formats 2/2A/2B/2C/2D are monitored and the number of available downlink resource blocks of the serving cell is 25 or more; or for special subframes with special subframe configuration 3, 4, 8 and normal downlink CP when DCI formats 2/2A/2B/2C/2D are monitored and the number of available downlink resource blocks of the serving cell is 25 or more; or for normal subframes and normal downlink CP when DCI formats 1A/1B/1D/1/2/2A/2B/2C/2D/0/4 are monitored, and when “n_{EPDCCH}38 <104; or for special subframes with special subframe configuration 3, 4, 8 and normal downlink CP when DCI formats 1A/1B/1D/1/2A/2/2B/2C/2D/0/4 are monitored, and when “n_{EPDCCH}”<104. Otherwise, case B is used.

The quantity “n_{EPDCCH}” (the number of REG available in an ECCE) for a particular mobile station device and referenced above is defined as the number of downlink REs in a PRB-pair configured for possible EPDCCH transmission of a EPDCCH-set fulfilling that they are part of any one of the 16 EREGs in the PRB-pair, they are assumed by the UE not to be used for CRS or for CSI-RS, and they are located in an OFDM symbol “1” equal or higher than the starting OFDM symbol (“1” is equal to or more than “I_{EPDHHHStart}”).

The format of the DCI depends on the purpose the ePDCCH is transmitted for. Format 0 is usually transmitted for uplink scheduling and uplink power control. Format 1 is usually transmitted for downlink SIMO (Single Input Multiple Output) scheduling and uplink power control. Format 2 is usually transmitted for downlink MIMO scheduling and uplink power control. Format 3 is usually transmitted for uplink power control. Format 4 is usually transmitted for uplink scheduling of up to four layers.

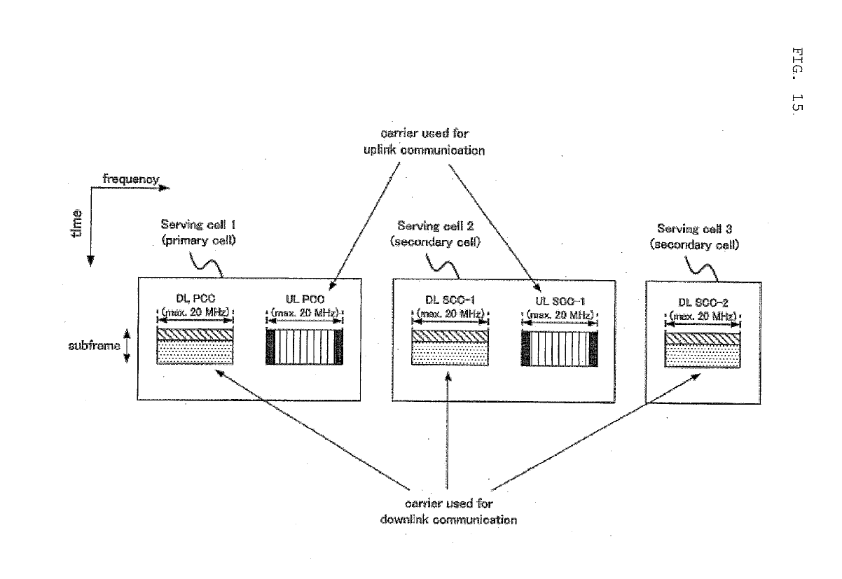

FIG. 15 is a diagram illustrating an example of cell aggregation (carrier aggregation) processing according to the present invention. In the figure, the horizontal axis represents the frequency domain and the vertical axis represents the time domain. In the illustrated cell aggregation processing illustrated, three serving cells (serving cell 1, serving cell 2, and serving cell 3) are aggregated. One of the plurality of aggregated serving cells is a primary cell (PCell). The primary cell is a serving cell having functions equivalent to those of a cell in LTE.

The serving cells other than the primary cell are secondary cells (SCells). The secondary cells have functions which are more limited than the primary cell, and are mainly used to transmit and receive the PDSCH and/or PUSCH. For example, the mobile station device 2 performs random access using only the primary cell. Also, the mobile station device 2 may not necessarily receive paging and system information transmitted on the PBCH and PDSCH of the secondary cells.

The carriers corresponding to serving cells in the downlink are downlink component carriers (DL CCs), and the carriers corresponding to serving cells in the uplink are uplink component carriers (UL CCs). The carrier corresponding to the primary cell in the downlink is a downlink primary component carrier (DL PCC), and the carrier corresponding to the primary cell in the uplink is an uplink primary component carrier (UL PCC). The carriers corresponding to the secondary cells in the downlink are downlink secondary component carriers (DL SCCs), and the carriers corresponding to the secondary cells in the uplink are uplink secondary component carriers (UL SCCs).

The base station device 1 necessarily sets both the DL PCC and the UL PCC as a primary cell. Also, the base station device 1 is capable of setting only the DL SCC or both the DL SCC and the UL SCC as a secondary cell. Further, the frequency or carrier frequency of a serving cell is called a serving frequency or serving carrier frequency, the frequency or carrier frequency of a primary cell is called a primary frequency or primary carrier frequency, and the frequency or carrier frequency of a secondary cell is called a secondary frequency or secondary carrier frequency.

The mobile station device 2 and the base station device 1 first start communication using one serving cell. Through this communication, the base station device 1 sets a set of one primary cell and one or a plurality of secondary cells for the mobile station device 2 by using an RRC signal (radio resource control signal). The base station device 1 is capable of setting a cell index for a secondary cell. The cell index of the primary cell is constantly zero. The cell index of the same cell may be different among the mobile station devices 1. The base station device 1 is capable of instructing the mobile station device 2 to change the primary cell using handover.

The serving cell 1 is the primary cell, and the serving cell 2 and the serving cell 3 are the secondary cells. Both the DL PCC and UL PCC are set in the serving cell 1 (primary cell), both the DL SCC-1 and UL SCC-1 are set in the serving cell 2 (secondary cell), and only the DL SCC-2 is set in the serving cell 3 (secondary cell).

The channels used in the DL CCs and UL CCs have the same channel structure as that in LTE. Each of the DL CCs has a region to which the PHICH, the PCFICH, and the PDCCH are mapped, which is represented by a region hatched with oblique lines, and a region to which the PDSCH is mapped, which is represented by a region hatched with dots. The PHICH, the PCFICH, and the PDCCH are frequency-multiplexed and/or time-multiplexed. The region where the PHICH, the PCFICH, and the PDCCH are frequency-multiplexed and/or time-multiplexed and the region to which the PDSCH is mapped are time-multiplexed. In each of the UL CCs, the region to which the PUCCH represented by a gray region is mapped, and the region to which the PUSCH represented by a region hatched with horizontal lines is mapped are frequency-multiplexed.

In cell aggregation, up to one PDSCH can be transmitted in each of the serving cells (DL CC), and up to one PUSCH can be transmitted in each of the serving cells (UL CC). In the example of the figure, up to three PDSCHs can be simultaneously transmitted using three DL CCs, and up to two PUSCHs can be simultaneously transmitted using two UL CCs.

Furthermore, in cell aggregation, a downlink assignment including information indicating the allocation of radio resources for the PDSCH in the primary cell, and an uplink grant including information indicating the allocation of radio resources for the PUSCH in the primary cell, are transmitted on the PDCCHs of the primary cell. The serving cell in whose PDCCH are transmitted a downlink assignment including information indicating the allocation of radio resources for the PDSCH in the secondary cell and an uplink grant including information indicating the allocation of radio resources for the PUSCH in the secondary cell is set by the base station device 1. This setting may vary among mobile station devices.

If a setting is made so that a downlink assignment including information indicating the allocation of radio resources for the PDSCH and an uplink grant including information indicating the allocation of radio resources for the PUSCH in a certain secondary cell are to be transmitted using a different serving cell (hereafter cross-carrier scheduling, as opposed to self-scheduling), the mobile station device 2 does not decode the PDCCH in this secondary cell. For example, if a setting is made so that a downlink assignment including information indicating the allocation of radio resources for the PDSCH and an uplink grant including information indicating the allocation of radio resources for the PUSCH in the serving cell 2 are to be transmitted using the serving cell 1 (cross-carrier scheduling), and that a downlink assignment including information indicating the allocation of radio resources for the PDSCH and an uplink grant including information indicating the allocation of radio resources for the PUSCH in the serving cell 3 are to be transmitted using the serving cell 3 (self-scheduling), the mobile station device 2 decodes the PDCCH in the serving cell 1 and the serving cell 3, and does not decode the PDCCH in the serving cell 2.

The base station device 1 sets, for each serving cell, whether or not a downlink assignment and an uplink grant include a carrier indicator, which indicates the serving cell whose PDSCH or PUSCH radio resources are allocated by the downlink assignment and the uplink grant. The PHICH is transmitted in the serving cell in which the uplink grant including the information indicating the allocation of radio resources for the PUSCH for which the PHICH indicates an ACK/NACK has been transmitted.

The base station device 1 is capable of deactivating and activating a secondary cell which has been set for the mobile station device 2 using MAC (Medium Access Control) CE (Control Element). The mobile station device 2 does not receive any physical downlink channels and signals and does not transmit any physical uplink channels and signals in a deactivated cell, and does not monitor downlink control information for the deactivated cell. The mobile station device 2 regards a secondary cell which is newly added by the base station device 1 as a deactivated cell. Note that the primary cell is not deactivated.

In an FDD (Frequency Division Duplex) wireless communication system, a DL CC and a UL CC corresponding to a single serving cell are constructed at different frequencies. In a TDD (Time Division Duplex) wireless communication system, a DL CC and a UL CC corresponding to a single serving cell are constructed at the same frequency, and an uplink subframe and a downlink subframe are time-multiplexed at a serving frequency.

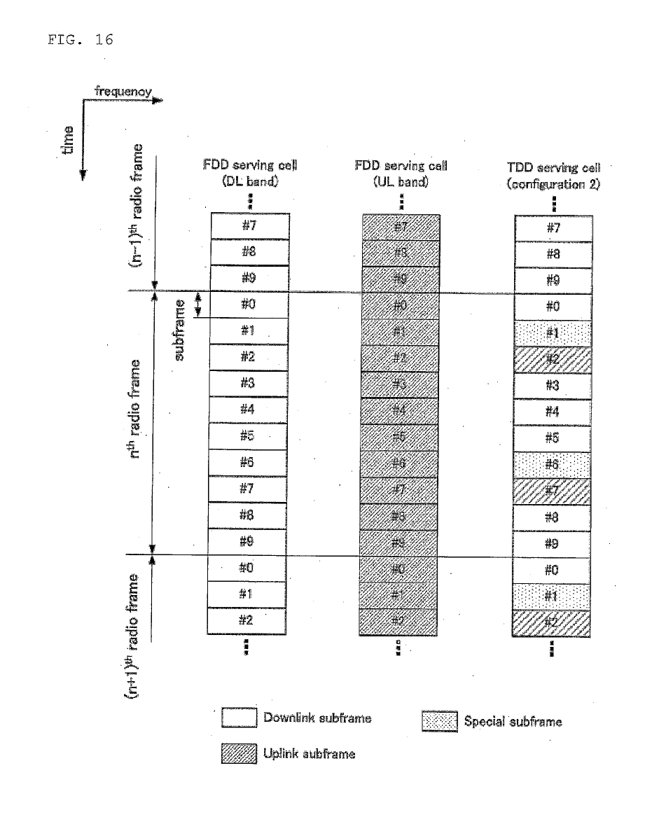

FIG. 16 is a diagram illustrating an example of the configuration of radio frames in a TDD-FDD CA (Carrier Aggregation) wireless communication system. This case is indistinctly referred to as TDD-FDD CA, or simply TDD-FDD in the document. The horizontal axis represents the frequency domain and the vertical axis represents the time domain. White rectangles represent downlink subframes, rectangles hatched with oblique lines represent downlink subframes, and rectangles hatched with dots represent special subframes. The number (#i) assigned to each subframe is the number of the subframe in the radio frame.

In the figure, an FDD serving cell and a TDD serving cell are aggregated. The FDD serving cell has a band configured for downlink in which all the subframes are used for downlink transmission, and another band configured for uplink in which all the subframes are used for uplink transmission. The TDD serving cell has only one band, where the downlink subframes, uplink subframes, and special subframes are multiplexed in time. In the example of the figure the TDD serving cell uses the UL/DL configuration 2.

If the FDD serving cell is the PCell and the TDD serving cell is the SCell the PCell follows its own HARQ timing, while the SCell follows the timing of the PCell. Instead of following the downlink set association described above, a mobile station device connected to a TDD SCell sends the HARQ indication of a message to the PCell through the FDD PUCCH following the FDD HARQ timing. As this channel is always available the mobile station device sends the HARQ indication in the subframe “n+4”, where “n” represents the subframe in which the reception of the related PDSCH took place, and a retransmission would occur in the subframe “n+8”.

The maximum number of simultaneous HARQ processes that can occur in a case in which a TDD serving cell is aggregated with an FDD serving cell depends on the configuration of the primary cell and the secondary cell.

Particularly, the case in which the TDD serving cell is the primary cell presents some challenges, because an FDD secondary cell adapts its HARQ timing to that of the TDD primary cell, therefore needing to address more HARQ processes than it is currently possible for FDD serving cells.

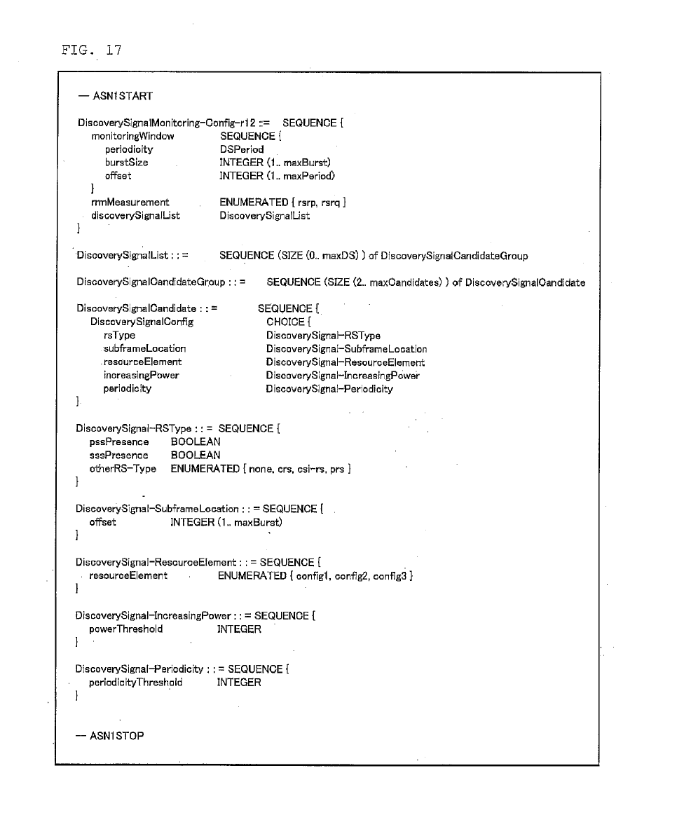

FIG. 17 shows an example of an information element (IE) that can be used for explicit indication of the discovery signal configuration. In particular, the information element is labeled as DiscoverySignalMonitoring-Config-r12. Higher layer parameters such as IEs are provided by higher layer signaling (or RRC signaling).

DiscoverySignalMonitoring-Config-r12 contains a parameter monitoringWindow, with information about the location of the discovery signal bursts; rrmMeasurement, configuring the mobile station device with the type of RRM measurement the mobile station device is expected to perform; and discoverySignalList, with information about the configuration of the discovery signals.

The parameter monitoringWindow comprises periodicity, which is configured as DSPeriod, and is the value in subframes of the periodicity of the discovery signal burst; burstSize, which is the number of subframes that a burst may span, up to a maximum of maxBurst; and offset, which is a parameter giving an indication of when the next burst will take place. In one example the discovery signal could take place with a periodicity of 100 subframes, spanning 3 subframes, the next discovery signal burst taking place 32 subframes after the RRC configuration message.

The parameter rtinMeasurement indicates the mobile station whether the RRM measurement to be applied to the discovery signal should be RSRP or RSRQ.

The parameter discoverySignalList gives the configuration of one or more possible types of discovery signals, and presents them in groups of two or more candidates. If no group is configured, then the mobile station device is not expected to monitor for discovery signals.

The IE DiscoverySignalCandidateGroup comprises at least two different candidates of discovery signals, configured by the IE Discovery Signal Candidate.

The IE DiscoverySignalCandidate comprises the configuration of a possible discovery signal candidate. There are a potentially large amount of discovery signals to be used. In an embodiment of the invention discovery signal there are defined candidates based on the reference signal of the discovery signal (DiscoverySignal-RSType), on the subframe location of the discovery signal in the burst (DiscoverySignal-SubframeLocation), on the resource element in use (DiscoverySignal-ResourceElement), on the measured and perceived power of the discovery signal (DiscoverySignal-IncreasingPower), and on the periodicity of the discovery signal with regard to the periodicity of the discovery signal burst periods (DiscoverySignal-Periodicity).

DiscoverySignal-RSType comprises a parameter indicating the presence of a PSS signal, a indicating the presence of a SSS signal, and a parameter indicating the presence of other reference signal. In an embodiment of the invention the possible additional reference signals are none (only PSS/SSS or a subset thereof), CRS, CSI-RS, or PRS. In another embodiment of the invention PSS/SSS are considered intrinsic to the discovery signal and no parameter is defined to indicate their presence. In another embodiment of the invention more than one additional reference signal type can be configured in the same signal via a bitmap or two or more of the appropriate parameters.

DiscoverySignal-SubframeLocation comprises a parameter offset, which in one embodiment of the invention points to a subframe of the discovery signal burst where the discovery signal candidate can be transmitted. In another embodiment of the invention there are more than one of these values, the discovery signal candidate being able to be transmitted in any or all of the pointed subframes.

DiscoverySignal-ResourceElement comprises a parameter resourceElement that configures one among a plurality of options of resource elements to be used by the discovery signal. In one embodiment of the invention the discovery signal uses PSS/SSS and CSI-RS. The parameter resourceElement indicates which of the resource elements CSI-RS can be in is actually used in the discovery signal (for example, a subsection of the resource elements, or all, or none, etc.).

DiscoverySignal-IncreasingPower comprises a parameter giving a power threshold over which a signal can be considered as a positive match for the configured candidate.

DiscoverySignal-Periodicity comprises a parameter giving a threshold of periodicity in discovery signal burst periods for the discovery signal. If the period of the discovery signal of a dormant cell is equal to or below the configured parameter the discovery signal can be considered as a positive match for the configured candidate.

The IE MeasObjectEUTRA defines the measurement conditions under which RRM measurements are performed (e.g. frequency, bandwidth, etc.). A black list is defined with the cell IDs of serving cells that the mobile station device should not perform RRM measurements on if detected. An optional cell list is also defined to accommodate the need for a measurement offset for certain cells. The list contains the cell IDs and the offset to be applied to measurements on those cells.

The IE ReportConfigEUTRA specifies criteria for triggering of an E-UTRA measurement reporting event. The E-UTRA measurement reporting events are labelled AN with N equal to 1, 2 and so on.

Event A1: Serving becomes better than absolute threshold;

Event A2: Serving becomes worse than absolute threshold;

Event A3: Neighbour becomes amount of offset better than PCell;

Event A4: Neighbour becomes better than absolute threshold;

Event A5: PCell becomes worse than absolute threshold1 AND Neighbour becomes better than another absolute threshold2;

Event A6: Neighbour becomes amount of offset better than SCell.

The threshold or thresholds associated with each of the events in the IE ReportConare configured separately through RRC configuration. The cell detection described in all embodiments can be based on the measurement reporting. For example, a UE can assume that a cell is detected when one of the E-UTRA measurement reporting events is triggered for its signal.

The methods and criteria specified in the IE MeasObjectEUTRA and ReportConfigEUTRA are applicable to discovery signals. In one embodiment of the invention a sole threshold is defined for all the discovery signal candidates. In another embodiment of the invention each discovery signal candidate is configured with a different threshold, which does not preclude some of these thresholds from being configured with the same value. As an example, the IE MeasObjectEUTRA is modified to comprise the discovery signal measurement conditions under which RRM measurements are performed. A black list is defined with the cell IDs of serving cells for which the mobile station device should not perform RRM measurements if their discovery signal is detected. An optional cell list is also defined to accommodate the need for a measurement offset for certain cells. The list contains the cell IDs and the offset to be applied to measurements of the discovery signals of those cells.

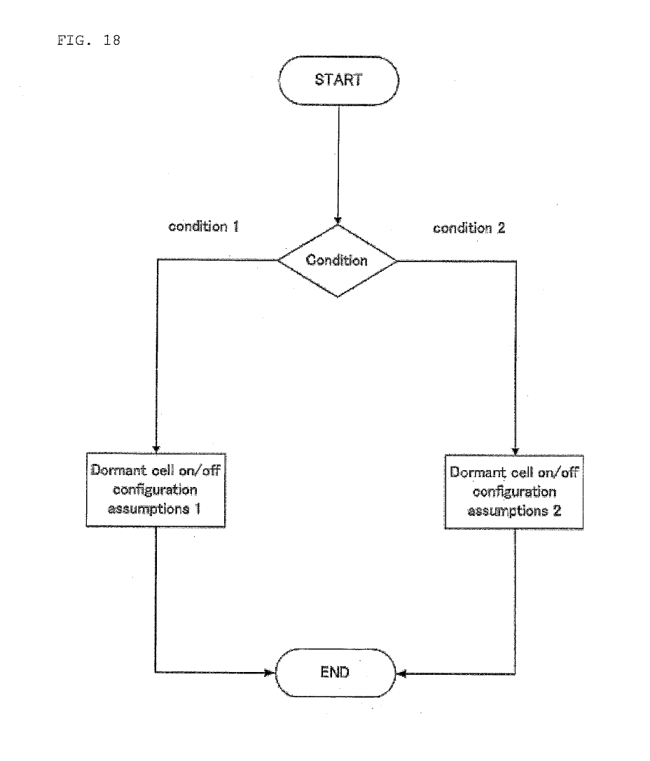

FIG. 18 illustrates a flow chart for the decision about the dormant cell on/off configuration assumptions inferred by the mobile station device through discovery signal detection.

The figure illustrates only two conditions, but in some cases there are three, four, or more different outcomes depending on a set of conditions. This figure is also used for those cases, understanding that an extension of it to accommodate the multiplicity of possible conditions is a trivial exercise. Alternatively, those cases can be thought as a series of binary conditions, in which condition 1 corresponds to a single condition and condition 2 corresponds to a bundle of all the remaining conditions together. If condition 2 is chosen, the process is repeated using one of the bundled conditions as the new condition 1, and the remaining ones as the new bundled condition 2. This process is iterated until a single condition is reached.

The mobile station device monitors for discovery signals with an RSRP or RSRQ level over a configured threshold, which are then considered to be detected, and checks the condition described herein. The dormant cell on/off configuration assumptions 1, 2, . . . shown in the flow chart can be different each time the condition is checked. Alternatively, the mobile station device may be configured with a different threshold for each different discovery signal candidate, in which case the decision about whether a discovery signal is considered detected or not relies on the configured threshold for the matching discovery signal candidate.

In one embodiment of the invention a mobile station device is configured with two candidate discovery signals belonging to the same discovery signal candidate group. The mobile station device assumes that the dormant cell is in the transition time between off and on states, or shortly going to wake up and enter the on state, if a discovery signal matching the first configured discovery signal candidate is received, and that the dormant cell is going to remain dormant for an indefinite amount of time if a discovery signal matching the second configured discovery signal candidate is received. Alternatively, the mobile station device may be configured with three or more discovery signal candidate signals, each giving an idea of the remaining off time depending on their configuration.

In one embodiment of the invention the base station device transmits discovery signals only in the off state. In another embodiment of the invention the base station device transmits discovery signals regardless of its state. In another embodiment of the invention the base station device transmits a first configured discovery signal candidate when it is in “off” state and not going to wake up soon; the base station device transmits a second configured discovery signal candidate during the transition time; and the base station device transmits a third configured discovery signal candidate while in the on state. In another embodiment of the invention the base station device transmits the second configured discovery signal candidate during the transition time and during the on state time. In another embodiment of the invention the base station device transmits the first and second configured discovery signal candidates during the transition time and only the second configured discovery signal candidate during the on state. Mobile station devices are expected to be configured to support one or more of these behaviors.

In an embodiment of the invention the exact remaining time in subframes from the detection of a discovery signal matching a particular discovery signal candidate until the base station device completes its transition to the on state is known and equal to “remaining time”. A base station device knows the transition time required to completely switch from the off state to the on state (“transition time”), and the base station device also knows the timing of the discovery signal bursts; the base station device starts the transition process “transition time - remaining time” subframes prior to the transmission of a discovery signal of the pertinent discovery signal candidate type.

In an embodiment of the invention, the mobile station device may send information to the primary cell regarding the detected dormant cells whose discovery signals have good measured RRM and match a second configured discovery signal candidate, a third configured discovery signal candidate, or beyond; if instead the mobile station device detects a discovery signal matching a first configured discovery signal candidate the mobile station device may start monitoring PDCCH/EPDCCH corresponding to that serving cell. The mobile station device may do so if the detected discovery signal matching the first configured discovery signal candidate has the highest RRM measurement value among the detected discovery signals. In another embodiment of the invention an offset is configured or predetermined to give priority to the discovery signals matching the first configured discovery signal candidates, even when their measured RRM is not the highest among all detected discovery signals. Alternatively, an offset could be configured or predetermined to give priority to discovery signals matching a second configured discovery signal candidate or beyond.

In an embodiment of the invention a first configured discovery signal candidate is configured with a certain combination of reference signals, while a second configured discovery signal candidate is configured with a different combination of reference signals, and subsequent discovery signal candidates are configured with different combinations of reference signals. The mobile station device searches for all possible discovery signal candidates and makes assumptions about a dormant cell on/off configuration according to the discovery signal candidate a detected RS matches with.

In another embodiment of the invention a first configured discovery signal candidate is expected by the mobile station device in a subset of one or more of the discovery signal burst subframes; a second configured discovery signal candidate are expected in a different subset of subframes; a third configured discovery signal candidate and beyond are expected in different subframes. The mobile station device monitors for all possible discovery signal candidates and makes assumptions about the dormant cell on/off configuration according to the discovery signal candidate the detected RS corresponds to.

In another embodiment of the invention the differentiation between discovery signal candidates depends on their RE mapping. A first configured discovery signal candidate is expected by the mobile station device to have discovery signal RS in a subset of the possible resource elements the RS can be transmitted in. A second configured discovery signal candidate and beyond are expected to have RS in different subsets of the possible resource elements the RS can be transmitted in. There may be resource elements in common between each of the possible pair of subsets of resource elements configured for the different discovery signal candidates. In another embodiment of the invention, a resource element can only belong to a subset corresponding to one discovery signal candidate. The mobile station device monitors for all possible discovery signal candidates and makes assumptions about the dormant cell on/off configuration according to the discovery signal candidate the detected RS corresponds to.

In another embodiment of the invention dormant cells increase the transmission power of their discovery signal progressively as the time to become active approaches. The mobile station device considers a detected discovery signal to match a first configured discovery signal candidate if the measured RRM is over a certain threshold. Multiple discovery signal candidates can be configured in this manner, the mobile station device considering the detected discovery signals to match one of the configured discovery signals candidates and assuming different on/off configurations depending on the case.

In another embodiment of the invention only one candidate is configured, the mobile station device assuming a given configuration for a cell whose discovery signal matches the configured discovery signal candidate.

In another embodiment of the invention a set of dormant cells transmit their discovery signals with a period that is a multiple of the period of the discovery signal burst. The dormant cells increase the periodicity as the time to become active approaches. A mobile station device configured with multiple discovery signal candidates assumes a configuration set for the cell whose discovery signal matches one of the configured discovery signal candidates.

In another embodiment of the invention only one candidate is configured, the mobile station device assuming a given configuration for a cell whose discovery signal matches the configured discovery signal candidate.

In another embodiment of the invention there are configured different groups of candidates with different configurations. The mobile station device monitors all of them and makes assumptions based on the discovery signal candidate the detected discovery signal matches.

The above described discovery signal candidate configurations and a combination thereof may be comprised without limitations in a same discovery signal candidate group. For example, a first configured discovery signal candidate may use CRS and be transmitted in a first subset of subframes inside the burst, while a second configured discovery signal candidate may use CSI-RS and be transmitted in a second subset of subframes inside the burst. Additionally, a third configured discovery signal may use PRS and be transmitted in any of the subframes of the discovery signal burst (that is, different configured discovery signals candidates may be transmitted in the same subframe(s) as others, the main differentiator between those other discovery signal candidates being their subframe location). In another example, a first configured discovery signal candidate is configured with CSI-RS and a subset of the possible CSI-RS resource elements, a second configured discovery signal candidate is configured with CSI-RS and a different subset of possible resource elements, and a third configured discovery signal candidate may be configured with PRS.

In another embodiment of the invention the parameter monitoring Window is a parameter inside the IE DiscoverySignalCandidateGroup. Different candidate groups are transmitted following different periodicity, discovery signal burst size, and/or offset.

Alternatively, any of the above described sets of discovery signal candidates could be fixed and predefined, without the requirement of the base station device having to configure their values to the mobile station devices.

In an embodiment of the invention the mobile station device starts monitoring the PDCCH/EPDCCH of a dormant active cell under certain dormant cell on/off assumptions. For example, the UE starts monitoring PDCCH/EPDCCH of a dormant cell that is becoming active in a short period of time.

Alternatively, the mobile station device waits a given amount of time after detecting a first configured discovery signal candidate and starts monitoring PDCCH/EPDCCH for that cell.

If a mobile station device is configured with DiscoverySignalMonitoring-Config-r12, and if the discovery signal indicated by DiscoverySignalCandidate 1 is detected, then the mobile station device shall not monitor PDCCH/EPDCCH.

If a mobile station device is configured with DiscoverySignalMonitoring-Config-r12, and if the discovery signal indicated by DiscoverySignalCandidate 0 is detected, then the mobile station device shall monitor PDCCH/EPDCCH.

In another embodiment of the invention the mobile station device starts a legacy procedure for cell detection and handover if a first configured discovery signal candidate is detected.

If a mobile station device is configured with DiscoverySignalMonitoring-Config-r12, and if the discovery signal indicated by DiscoverySignalCandidate 0 is detected, then the UE shall perform legacy procedure (e.g. PSS/SSS/CRS detection).

In another embodiment of the invention the RRM report of the mobile station device is different depending on the detected dormant cells on/off assumptions.

If a mobile station device is configured with DiscoverySignalMonitoring-Config-r12, and if the discovery signal indicated by DiscoverySignalCandidate 1 is detected, then the mobile station device shall report the RRM measurement result of the small cell.

If a mobile station device is configured with DiscoverySignalMonitoring-Config-r12, and if the discovery signal indicated by DiscoverySignalCandidate 0 is detected, then the mobile station device shall measure RRM (RSRP/RSRQ) using legacy procedure (e.g. by CRS).

A program operated in the base station device and the mobile station devices according to the present invention may be a program (program causing a computer to function) for controlling a CPU (Central Processing Unit) or the like so as to realize the functions of the above-described embodiments according to the present invention. The information handled in these devices is temporarily stored in a RAM (Random Access Memory) during the processing of the information, being thereafter stored in various kinds of ROMs such as a flash ROM (Read Only Memory) or an HDD (Hard Disk Drive), and is read out, corrected, or written by the CPU as necessary.

Part of the mobile station devices and the base station device according to the above-described embodiments may be implemented by a computer. In that case, a program for implementing this control function may be recorded on a computer-readable recording medium, and a computer system may be caused to read and execute the program recorded on the recording medium.

Here, the “computer system” is a computer system included in each of the mobile station devices or the base station device, and includes hardware such as an OS and peripheral devices. The “computer-readable recording medium” is a portable medium such as a flexible disk, a magneto-optical disk, a ROM, or a CD-ROM, or a storage device such as a hard disk included in the computer system.

Furthermore, the “computer-readable recording medium” may also include an object that dynamically holds a program for a short time, such as a communication line used to transmit the program via a network such as the Internet or a communication line such as a telephone line, and an object that holds a program for a certain period of time, such as a volatile memory in a computer system serving as a server or a client in this case. Also, the above-described program may implement some of the above-described functions, or may be implemented by combining the above-described functions with a program which has already been recorded on a computer system.

Furthermore, part or whole of the mobile station devices and the base station device in the above-described embodiment may be implemented as an LSI, which is typically an integrated circuit, or as a chip set. The individual functional blocks of the mobile station devices and the base station device may be individually formed into chips, or some or all of the functional blocks may be integrated into a chip. The method for forming an integrated circuit is not limited to LSI, and may be implemented by a dedicated circuit or a general-purpose processor. In a case where the progress of semi-conductor technologies produces an integration technology which replaces an LSI, an integrated circuit according to the technology may be used.

While some embodiments of the present invention have been described in detail with reference to the drawings, specific configurations are not limited to those described above, and various design modifications and so forth can be made without deviating from the gist of the present invention.

### REFERENCE SIGNS LIST

1 Base station device

2 Mobile station device

3 PDCCH/ePDCCH

4 Downlink data transmission

5 Physical Uplink Control Channel

6 Downlink data transmission

7 Discovery signal

10 Dormant base station device

101 Higher layer processing circuit

1011 Wireless resource management circuit

1015 Scheduling circuit

1017 CSI report management circuit

103 Control circuit

105 Reception circuit

1051 Decoding circuit

1053 Demodulation circuit

1055 Demultiplexing circuit

1057 Radio reception circuit

1059 Channel estimation circuit

107 Transmission circuit

1071 Coding circuit

1073 Modulation circuit

1075 Multiplexing circuit

1077 Radio transmission circuit

1079 Uplink reference signal generation circuit

109 Antenna circuit

301 Higher layer processing circuit

3011 Wireless resource management circuit

3015 Scheduling circuit

3017 CSI report management circuit

303 Control circuit

305 Reception circuit

3051 Decoding circuit

3053 Demodulation circuit

3055 Demultiplexing circuit

3057 Radio reception circuit

3059 Channel estimation circuit

307 Transmission circuit

3071 Coding circuit

3073 Modulation circuit

3075 Multiplexing circuit

3077 Radio transmission circuit

3079 Uplink reference signal generation circuit

309 Antenna circuit

1. A mobile station device comprising
a first circuit configured with a plurality of discovery signal candidates; and
a second circuit adapted to perform monitoring for the discovery signal candidates; and
a third circuit adapted to identify a detected discovery signal with one of the discovery signal candidates.

2. The mobile station device according to claim 1,
wherein the discovery signal candidates differ between them in the combination of reference signals they are configured with,
a first discovery signal candidate being based on a combination of reference signals; and
a second discovery signal candidate being based on a different combination of reference signals; and
subsequently configured discovery signal candidates being based on a combination of reference signals that is different from the combination of reference signals of the previously configured discovery signal candidates.

3. The mobile station device according to claim 1,
wherein the discovery signal candidates differ between them in the subset of subframes within the discovery signal burst they are transmitted on,
a first discovery signal candidate being transmitted on a subset of subframes; and
a second discovery signal candidate being transmitted on a different subset of subframes; and
subsequently configured discovery signal candidates being transmitted on a subset of subframes that is different from the subset of subframes of the previously configured discovery signal candidates.

4. The mobile station device according to claim 1,
wherein the discovery signal candidates differ between them in the subset of resource elements within the physical resource block they are transmitted on,
a first discovery signal candidate being transmitted on a subset of resource elements; and
a second discovery signal candidate being transmitted on a different subset of resource elements; and
subsequently configured discovery signal candidates being transmitted on a subset of resource elements that is different from the subset of resource elements of the previously configured discovery signal candidates.

5. The mobile station device according to claim 1,
wherein the discovery signal candidates differ between them in the transmission power used for their transmission,
a first discovery signal candidate being transmitted with a given transmission power; and
a second discovery signal candidate being transmitted with a different transmission power; and
subsequently configured discovery signal candidates being transmitted with a transmission power that is different from the transmission power of the previously configured discovery signal candidates.

6. The mobile station device according to claim 1,
wherein the discovery signal candidates differ between them in the period they are transmitted with, the period being a multiple of the period of the discovery signal burst,
a first discovery signal candidate being transmitted with a given period; and
a second discovery signal candidate being transmitted with a different period; and
subsequently configured discovery signal candidates being transmitted with a period that is different from the period of the previously configured discovery signal candidates.

7. The mobile station device according to claim 1,
wherein the mobile station device assumes a state or set of parameters of the serving cell transmitting a detected discovery signal based on the discovery signal candidate the detected discovery signal matches with.

8. The mobile station device of claim 7 further comprising a circuit to compare the RRM measurement of the detected discovery signals' cells; and
another circuit to report to the primary serving cell the identities of the cells with the largest RRM measured values.

9. The mobile station device of claim 7 further comprising a circuit to compare the RRM measurement of the detected discovery signals' cells; and
another circuit to monitor the PDCCH/EPDCCH of a cell whose detected discovery signal's RRM measurement is over a configured threshold and matches one of the configured discovery signal candidates.

10. The mobile station device of claim 9,
wherein the RRM measurements is performed with an offset whose value depends on the configured discovery signal candidate the discovery signal matches with before performing RRM measurement comparisons.

11. The mobile station device of claim 7,
wherein the mobile station device starts a procedure for cell detection in a cell whose discovery signal matches one of the configured discovery signal candidates.

12. The mobile station device of claim 11 further comprising a circuit to prepare a first RRM report format for RRM measurements of discovery signals matching a first subset of discovery signal candidates; and
another circuit to prepare a second RRM report format for RRM measurements of discovery signals matching the discovery signal candidates that are not part of the first subset.

13. The mobile station device of claim 12 further comprising a circuit to compare the RRM measurement values of the detected discovery signals,
wherein the mobile station device prepares only the first or the second RRM report format based on the discovery signal candidate the detected discovery signal with the largest RRM measurement value matches with.

14. (canceled)

15. A base station device comprising
a first circuit configured with a plurality of discovery signal candidates; and
a second circuit adapted to select a discovery signal candidate according to a set of configured conditions; and
a third circuit adapted to prepare and transmit the selected discovery signal candidate.

16. The base station device according to claim 15,
wherein the discovery signal candidates differ between them in the combination of reference signals they are configured with,
a first discovery signal candidate being based on a combination of reference signals; and
a second discovery signal candidate being based on a different combination of reference signals; and
subsequently configured discovery signal candidates being based on a combination of reference signals that is different from the combination of reference signals of the previously configured discovery signal candidates.

17. The base station device according to claim 15,
wherein the discovery signal candidates differ between them in the subset of subframes within the discovery signal burst they are transmitted on,
a first discovery signal candidate being transmitted on a subset of subframes; and
a second discovery signal candidate being transmitted on a different subset of subframes; and
subsequently configured discovery signal candidates being transmitted on a subset of subframes that is different from the subset of subframes of the previously configured discovery signal candidates.

18. The base station device according to claim 15,
wherein the discovery signal candidates differ between them in the subset of resource elements within the physical resource block they are transmitted on,
a first discovery signal candidate being transmitted on a subset of resource elements; and
a second discovery signal candidate being transmitted on a different subset of resource elements; and
subsequently configured discovery signal candidates being transmitted on a subset of resource elements that is different from the subset of resource elements of the previously configured discovery signal candidates.

19. The base station device according to claim 15,
wherein the discovery signal candidates differ between them in the transmission power used for their transmission,
a first discovery signal candidate being transmitted with a given transmission power; and
a second discovery signal candidate being transmitted with a different transmission power; and
subsequently configured discovery signal candidates being transmitted with a transmission power that is different from the transmission power of the previously configured discovery signal candidates.

20. The base station device according to claim 15,
wherein the discovery signal candidates differ between them in the period they are transmitted with, the period being a multiple of the period of the discovery signal burst,
a first discovery signal candidate being transmitted with a given period; and
a second discovery signal candidate being transmitted with a different period; and
subsequently configured discovery signal candidates being transmitted with a period that is different from the period of the previously configured discovery signal candidates.

21. (canceled)
